(19) United States
(12) Patent Application Publication
(10) Pub. No.: US 2025/0010242 A1
(43) Pub. Date: Jan. 9, 2025

(54) REVERSE OSMOSIS CENTRIFUGE

(71) Applicant: Eden Technologies, Inc., Washington, UT (US)

(72) Inventors: Hunter Ferdinand Manz, Washington, UT (US); Zachary Wayne Manweiler, St. George, UT (US); Olvian Manz, Las Vegas, NV (US)

(21) Appl. No.: 18/894,387

(22) Filed: Sep. 24, 2024

Related U.S. Application Data
(63) Continuation-in-part of application No. 18/375,694, filed on Oct. 2, 2023, now Pat. No. 12,138,590.
Application No. 18/375,694 is a continuation of application No. 17/808,930, filed on Jun. 24, 2022, now Pat. No. 11,772,047.
Application No. 17/808,930 is a continuation-in-part of application No. 16/899,198, filed on Jun. 11, 2020, now abandoned.
(60) Provisional application No. 63/311,526, filed on Feb. 18, 2022.
(60) Provisional application No. 62/859,786, filed on Jun. 11, 2019.

(51) Int. Cl. B01D 61/06; B01D 15/36; B01D 61/02; B01D 61/08; B01D 63/16

(52) U.S. Cl. CPC B01D 61/06; B01D 15/361; B01D 61/025; B01D 61/026; B01D 61/08; B01D 63/16; B01D 2311/08; B01D 2311/2623; B01D 2313/243; B01D 2313/246; B01D 2313/90; B01D 2317/022

(57) ABSTRACT

The reverse osmosis centrifuge converts rotational energy into fluid velocity and conserves the energy placed into the concentrate. As concentrate travels back towards the center of the reverse osmosis centrifuge, the velocity of the fluid is converted into rotational force, thus conserving energy. To accomplish this, the reverse osmosis centrifuge includes a stationary cylindrical housing having a vacuum chamber and a vacuum pump for generating vacuum pressure in the vacuum chamber, a driveshaft coupled to a membrane cylinder rotatable within the stationary cylindrical housing, the membrane cylinder having a plurality of vertical desalination membranes, and an energy recovery turbine. The reverse osmosis centrifuge can be placed on the concentrate or waste stream outlet of a desalination or reverse osmosis facility to increase freshwater production.

### CROSS-REFERENCE TO RELATED APPLICATIONS

This application is a continuation in part of U.S. patent application Ser. No. 18/375,694, filed on Oct. 2, 2023, which application is a continuation of U.S. patent application Ser. No. 17/808,930, filed on Jun. 24, 2022 and issued as U.S. Pat. No. 11,772,047 on Oct. 3, 2023, which application claims the benefit of U.S. Provisional Patent Application No. 63/311,526, filed on Feb. 18, 2022, and is a continuation-in-part of U.S. patent application Ser. No. 16/899,198, filed on Jun. 11, 2020, which application claims the benefit of U.S. Provisional Patent Application No. 62/859,786, filed on Jun. 11, 2019, all of which are incorporated herein by reference.

### TECHNICAL FIELD

The present disclosure relates to desalination. More particularly, the present disclosure relates to a centrifugal system and method to aid in desalination of water.

### BACKGROUND

Because human life depends upon fresh water, there is a constant need to find new sources or to uncover ways of producing fresh water. Due to the amount of saltwater on the planet, there is an obvious need to convert the salt water to fresh water. As a result, several desalination methods exist in the art, including ultrasonic methods, electrolysis, and other specialized pumping. However, these methods of desalination are very expensive, which prohibits them from being widely utilized. As a result, water shortages and droughts continue to exist for societies, even when those societies are next to oceans-our largest bodies of water. For example, California constantly faces water shortages and droughts despite being on the coast.

Much of the cost of desalination results from the energy consumption required to produce it. Most current methods of desalination rely on pressure. Currently, massive pumps are used to produce the pressure needed for desalination. As a result, these pumps consume a massive amount of energy, making them cost-prohibitive for many uses. Further, a majority of the energy placed into the system is lost in the saline concentrate produced as part of the filtration process. Accordingly, if a system and method could reduce the energy required to desalinate, the cost would decrease, thereby allowing wider use of desalinating technology and societies being less susceptible to droughts during dry seasons.

Centrifugal Reverse Osmosis has been introduced as a solution to one or more of the problems above. However, attempts at centrifugal reverse osmosis have failed to be successful in the marketplace. This may be the result of several factors, which may include the production amount of fresh water, the cost to replace current systems with reverse osmosis systems, placement of the system within the desalination plant, system design for ease of manufacturing, effective permeate water energy recovery, vacuum vapor suppression methods, or other barriers or problems.

Therefore, there remains a need for a system and method that can desalinate water at significantly reduced cost and that can prevent loss of energy in the system. Further, there is great need for a desalination system that may be added to current desalination systems, eliminating the need to replace equipment, and enhancing the freshwater production while keeping additional costs lower, among other needs. The present reverse osmosis centrifuge disclosed herein solves these and other problems.

### SUMMARY OF EXAMPLE EMBODIMENTS

In some embodiments, a reverse osmosis centrifuge comprises a support shaft, a plurality of receiving tubes, a plurality of housings with filters therein, a plurality of departure tubes, and a permeate trough. The plurality of receiving tubes is coupled to a top of the plurality of housings, while the plurality of departure tubes are coupled to a bottom of the plurality of housings. As seawater enters the receiving tubes, it flows to the plurality of housings, where centrifugal force creates the permeate (i.e., fresh water) and concentrate (i.e., brine) in the plurality of housings. The permeate exits the plurality of housings and is deposited into the trough. The concentrate travels through, and exits from, the plurality of departure tubes.

In some embodiments, a reverse osmosis centrifuge comprises a rotatable housing having a water inlet and a plurality of water outlet arms, the rotatable housing being motor controlled. Each water outlet arm extends radially from the rotatable housing, the distal end of each arm comprising a saltwater outlet and a freshwater outlet. The reverse osmosis centrifuge further comprises a trough for receiving the output from the saltwater outlet and freshwater outlet, the trough divided so as to ensure separation of the fresh water from the saltwater. In some embodiments, the housing is an oblate spheroid. As a result, the water therein easily flows to the plurality of water outlets and through each arm. Pressure builds at the end of each arm due to rotational forces and the length of the arms. Accordingly, the rotationally-induced pressure (which may be referred to as “centrifugal” force) provides for desalination at a lower energy cost. Throughout this application, reference is made to desalination. However, it will be understood by one of ordinary skill in the art that centrifugal filters of the type described herein may be used for removing other contaminants from water beside salt and that desalination as used herein also refers to the removal of other substances from water by any compatible process.

In some embodiments, a reverse osmosis centrifuge comprises a stationary cylindrical housing with a driveshaft extending longitudinally through the cylindrical housing; the driveshaft configured to rotate freely and comprising a water inlet at a first end and a concentrate outlet on a second end; a plurality of receiving tubes carries saltwater from the water inlet to a plurality of vertical desalination membranes configured to separate freshwater from saltwater; the desalination membranes are coupled to the driveshaft via one or more support arms; as the driveshaft rotates, the plurality of membranes likewise rotate inside of the cylindrical housing; a vacuum pump reduces windage and other oppositional forces, allowing the rotor (i.e., driveshaft coupled to desalination membranes) greater spinning efficiency; freshwater exits through a plurality of freshwater outlets at the bottom of the desalination membranes and saltwater travels from the desalination membranes to the concentrate outlet via a plurality of saltwater membrane lines; an energy recovery turbine is positioned below the freshwater outlets and is configured to spin independently and at a reduced speed as compared to the driveshaft; as freshwater exits, the force spins the energy recovery turbine which is geared to the drive shaft and/or produces electricity via an alternator; or is tied to that axle via a mechanical gear train, where the turbine rotates at a fixed, reduced speed. The freshwater may be pumped from within the housing via a pump; and a vacuum turbine is coupled to the rotor to deflect and thereby prevent water vapor from rising inside the housing.

In some embodiments, a system for desalination comprises a reverse osmosis centrifuge coupled to the waste stream of a reverse osmosis system, the reverse osmosis centrifuge further desalinating the received waste stream, thereby producing additional freshwater that exits out one or more freshwater outlets and saltwater concentrate passing to one or more holding tanks, to additional treatment systems or other facilities, or back to the ocean. In some embodiments, Molecular Recognition Technology is performed on the concentrate of the holding tanks.

### BRIEF DESCRIPTION OF THE DRAWINGS

FIG. 1 illustrates a top perspective view of a reverse osmosis centrifuge;

FIG. 2 illustrates a top plan view of a reverse osmosis centrifuge;

FIG. 3 illustrates a bottom plan view of a reverse osmosis centrifuge;

FIG. 4 illustrates a side elevation view of a reverse osmosis centrifuge;

FIG. 5 illustrates a detailed, top perspective view of first trough and a fluid inlet of a reverse osmosis centrifuge;

FIG. 6 illustrates a perspective view of a receiving tube, a housing, and a departure tube of a reverse osmosis centrifuge;

FIG. 7 illustrates a cross-sectional view of a filter and a housing of a reverse osmosis centrifuge;

FIG. 8 illustrates a detailed, bottom perspective view of a housing and a permeate trough of a reverse osmosis centrifuge;

FIG. 9 illustrates a detailed, bottom perspective view of a second trough of a reverse osmosis centrifuge;

FIG. 10 illustrates a pressure gradient of a reverse osmosis centrifuge;

FIG. 11 illustrates a top perspective view of a reverse osmosis centrifuge;

FIG. 12 illustrates a top, side perspective view of a reverse osmosis centrifuge;

FIG. 13 illustrates a side perspective view of a reverse osmosis centrifuge;

FIG. 14 illustrates a bottom perspective view of a reverse osmosis centrifuge;

FIG. 15 illustrates a longitudinal cross-section of a reverse osmosis centrifuge;

FIG. 16 illustrates a top perspective view of a of a reverse osmosis centrifuge with the housing removed;

FIG. 17 illustrates a bottom, partial perspective view of a reverse osmosis centrifuge with a housing removed;

FIG. 18 illustrates a partial, bottom side perspective view of a reverse osmosis centrifuge with a housing removed;

FIG. 19 illustrates a bottom, partial perspective view of a reverse osmosis centrifuge with a housing removed;

FIG. 20 illustrates a partial, detailed cross-section of a reverse osmosis centrifuge;

FIG. 21 illustrates a longitudinal cross-section of a reverse osmosis centrifuge;

FIG. 22 illustrates a bottom perspective view of a reverse osmosis centrifuge with a housing removed;

FIG. 23 illustrates a horizontal cross-section of a reverse osmosis centrifuge;

FIG. 24 is a diagram illustrating the flow of water through a reverse osmosis centrifuge;

FIG. 25 is a diagram of a system utilizing a reverse osmosis centrifuge;

FIG. 26 is a diagram of system utilizing a reverse osmosis centrifuge;

FIG. 27 is a top, perspective view of a reverse osmosis centrifuge;

FIG. 28 is a top, perspective view of a reverse osmosis centrifuge with a portion of the housing removed; and

FIG. 29 illustrates the flow of water through the reverse osmosis centrifuge of FIGS. 27-28.

FIG. 30 illustrates embodiments of an array of centrifuge assemblies.

FIG. 31 shows a top perspective view of a centrifuge assembly.

FIG. 32 shows a top perspective view of an enclosure of a centrifuge assembly with the lid removed.

FIG. 33 shows a cross-sectional view of a centrifuge assembly.

FIG. 34 shows a perspective view of a permeate recovery turbine.

FIG. 35 shows a cross-sectional view including fresh water recovery portions of a centrifuge assembly.

FIG. 36 shows a top perspective view of an enclosure of a centrifuge assembly.

FIG. 37 shows a cross-sectional view of the enclosure of FIG. 36.

FIG. 38 shows a cross-sectional, perspective view of an embodiment of portions of a centrifuge assembly.

FIG. 39 shows an embodiment consistent with FIG. 38 with portions of a clean water sump removed for visibility.

FIG. 40 shows an embodiment consistent with FIG. 38 with additional components shown.

FIG. 41 shows a top plan view of an embodiment of a base bearing foot in accordance with embodiments of the centrifuge assembly.

FIG. 42 shows a cross-sectional view of the base bearing foot of FIG. 41.

FIG. 43 shows a perspective view of the base bearing foot of FIG. 41.

FIG. 44 shows a cross-sectional, perspective view of an embodiment consistent with FIG. 38 with a centrifuge rotor shown.

FIG. 45 shows a cross-sectional, perspective view of an embodiment of a centrifuge rotor.

FIG. 46 shows a perspective view of an embodiment consistent with the centrifuge rotor of FIG. 45.

FIG. 47 shows a cross-sectional, perspective view of an embodiment consistent with FIG. 38 with a turbine shown.

FIG. 48 shows a cross-sectional, perspective view of an embodiment of a turbine.

FIG. 49 shows a perspective view of turbine blades consistent with the embodiment of FIG. 47.

FIG. 50 shows a perspective view of an embodiment of a drivetrain.

FIG. 51 shows a cross-sectional view of an embodiment consistent with FIG. 50.

FIG. 52 shows a perspective view of an embodiment consistent with FIG. 50 with components removed for visibility.

FIG. 53 shows a perspective view of an embodiment of a centrifuge rotor including sensors.

FIG. 54 shows a perspective view of an embodiment of portions of a bearing foot and rotor hub with components removed for visibility.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in some embodiments,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there remains a need for a system and method that can desalinate water at significantly reduced cost, increase freshwater production, and that can prevent loss of energy in the system. As will be appreciated from this disclosure, the reverse osmosis centrifuge solves these problems and others.

Typical reverse osmosis systems for desalination comprise a reverse osmosis train (“RO Train”), which may include an intake, a high-pressure pump, a filter separated from the pump, and an energy recovery device. Filters used in reverse osmosis are unique because they require “Cross Flow Filtration.” To initiate the filtering process, the pump on typical RO Trains pushes salt water through the filter. With Cross Flow Filtration, a majority of the water mass moves across the filter, which is the saline concentrate. A desired feature of Cross Flow Filtration is that the large amount of concentrate acts as a cleanser as it moves across the filter, removing particles and prolonging the life of the filter. The water that does penetrate the filter is known as permeate and is often a small volume by percentage (e.g., 9%). The only valuable work produced by the reverse osmosis process is the permeate. However, energy is consumed by both the permeate and the concentrate. Because the concentrate is the waste product, the energy consumed by the concentrate is lost. To salvage some of the lost energy, energy recovery devices have been implemented in RO Trains. Energy recovery devices allow some of the energy that is placed into the system to be recovered. In particular, the energy recovery device was implemented in an attempt to transfer energy from the concentrate to the feed flow so as to not lose the majority of the energy consumed by the concentrate.

In contrast, the reverse osmosis centrifuge, described herein, generally conserves the energy of the concentrate by converting it to rotational energy. In some embodiments, the reverse osmosis centrifuge comprises a plurality of receiving tubes, a plurality of departure tubes, a support shaft, a plurality of housings with filters therein, and a trough. The plurality of receiving tubes is coupled to a top of the plurality of housings, while the plurality of departure tubes are coupled to a bottom of the plurality of housings. As seawater enters the receiving tubes, it flows to the plurality of housings, where centrifugal force creates the permeate and concentrate via the filters.

Centrifugal force (also known as a fictitious force) is an inertial force. This inertial force creates radial outward movement and pressure. Generally speaking, the faster an object is spinning, the greater the radially-outward force. This outward force creates pressure on seawater. The reverse osmosis centrifuge creates radial force on water entering the plurality of housings. The faster the plurality of housings spin, the greater the pressure. Unlike a RO Train, used in the prior art, where the pump is separated from the filter elements, the reverse osmosis centrifuge creates efficiencies by combining the pumping action and the filtration action into one revolving/centrifuge apparatus. Through the design of the reverse osmosis centrifuge, many major components of a RO Train become irrelevant. The two major components being replaced are the high-pressure pump and energy recovery device. Both of these devices are inherent features of the reverse osmosis centrifuge. It will be appreciated that the reverse osmosis centrifuge operates on the principle of taking water to a high pressure state, exhausting a fixed percentage of that water through the filters, and then recovering the energy in the concentrate water by taking it to a low pressure state before ejection through the plurality of departure tubes, thereby foregoing the need for an energy recovery device. Thus, and in stark contrast to the prior art, the reverse osmosis centrifuge is a cross flow filtration device that only exhausts energy into the filtered water (i.e., permeate) and not the concentrate.

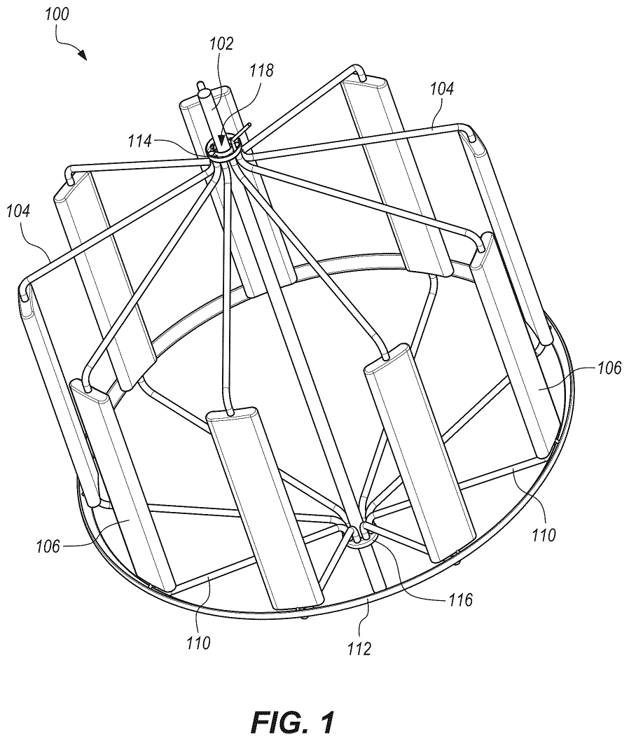

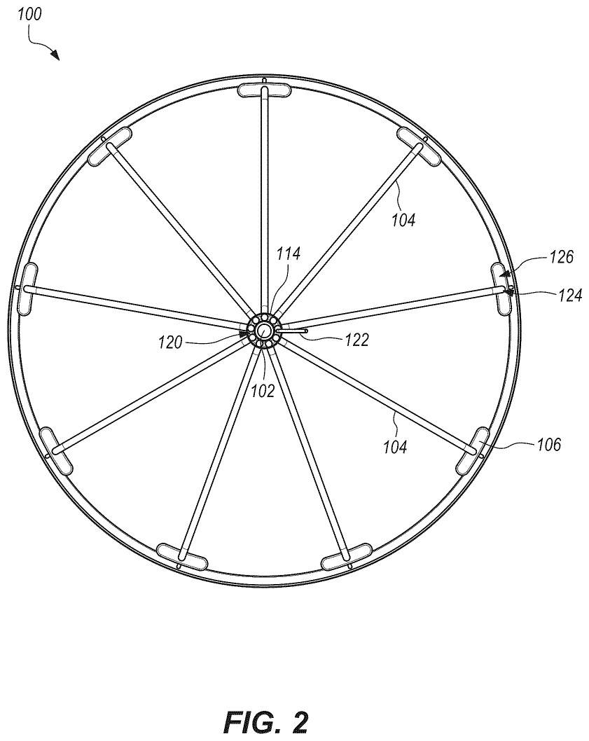

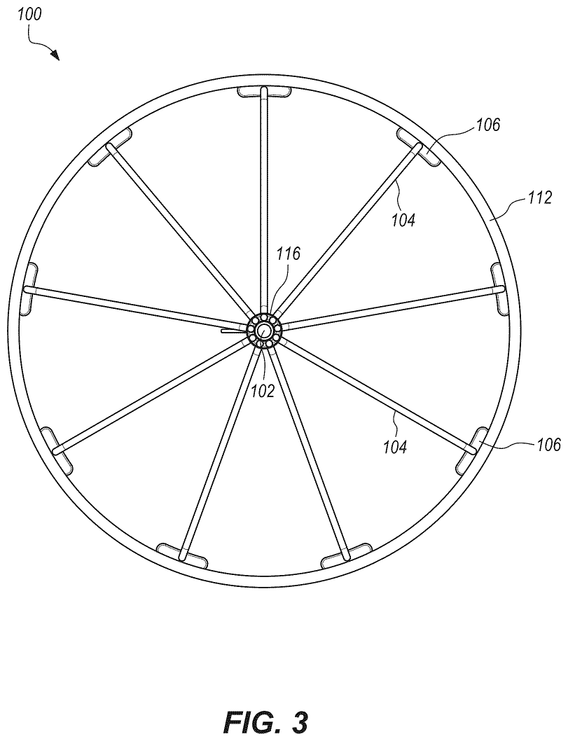

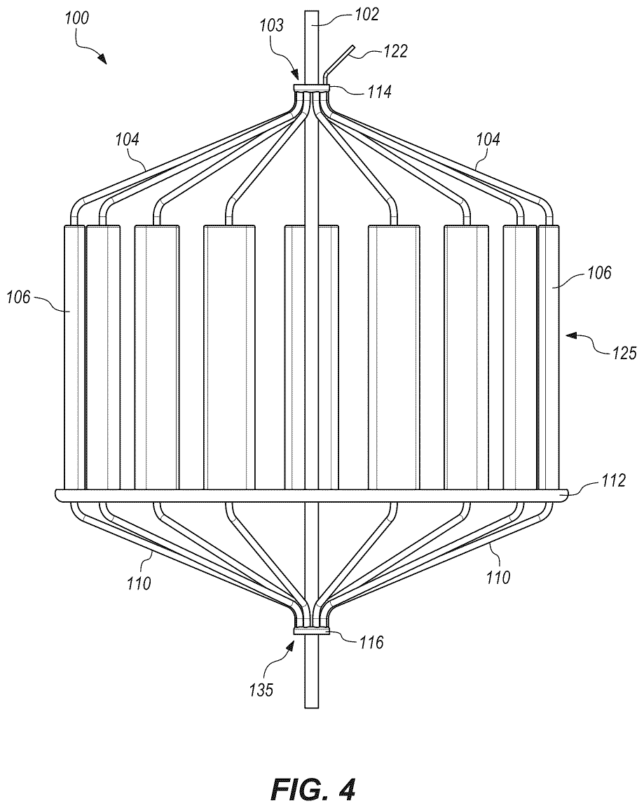

As shown in FIGS. 1-5, in some embodiments, a reverse osmosis centrifuge 100 comprises a support shaft 102, a plurality of receiving tubes 104, a plurality of housings 106 with filters 108 (e.g., reverse osmosis membranes) therein, a plurality of departure tubes 110 for the outlet of concentrate, and a permeate trough 112. The reverse osmosis centrifuge 100 may be six feet in diameter and eight feet tall. However, the reverse osmosis centrifuge 100 is not limited to those dimensions and may be other dimensions, depending upon the available energy input and desired output amount. The support shaft 102 may receive a first trough 114 and a second trough 116. The support shaft 102 may rotate (e.g., motor-controlled), thereby rotating the first and second troughs 114, 116 coupled thereto. In an alternate embodiment, the support shaft 102 may be static while the first and second troughs 114, 116 have bearings and be motor-controlled so as to rotate around the support shaft 102. The first trough 114 comprises a first support shaft aperture 118 so as to receive the support shaft 102 at a first end 103 (FIG. 4). The first trough 114 further comprises a plurality of first apertures 120. While a plurality of apertures 120 are shown, it will be appreciated that one or more apertures may be used on the first trough 114. Further, the plurality of receiving tubes 104 are coupled to the plurality of apertures 120 via a securement mechanism, such as glue, crimping, twist and lock, threads, screws, etc.

When the reverse osmosis centrifuge 100 begins to operate, saltwater enters the first trough 114 by way of a fluid inlet 122. While saltwater may enter the reverse osmosis centrifuge 100, it will be appreciated that the reverse osmosis centrifuge 100 may be used with salt-free water as well. A single fluid inlet 122 is shown; however, there may be a plurality of fluid inlets so as to deposit additional saltwater into the system. The shape and form of the fluid inlet 122 may also vary. For example, the fluid inlet 122 may be non-angled and have a large diameter. Further, in some embodiments, the first trough 114 may be sealed with, for example, a cap so that water entering through a sealed fluid inlet 122 can pressurize the system, preventing backflow of the seawater and providing for the removal of the viscous concentrate from the plurality of departure tubes 110. In some embodiments, water entering the fluid inlet 122 may be pressurized, such as by using a pump.

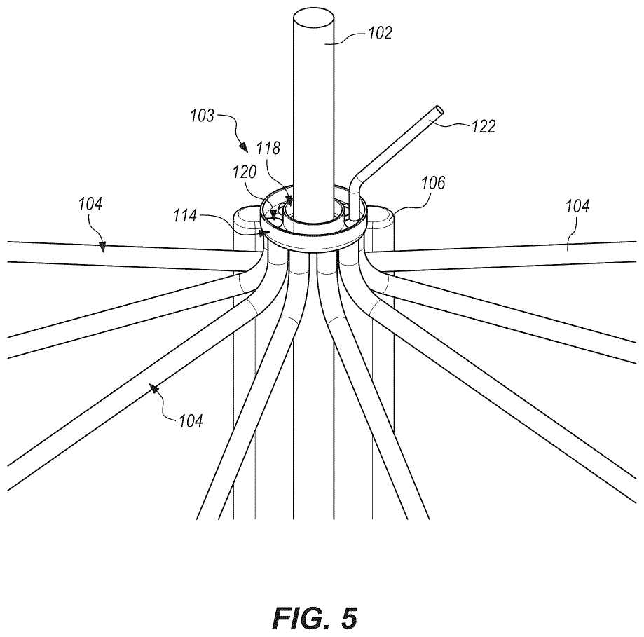

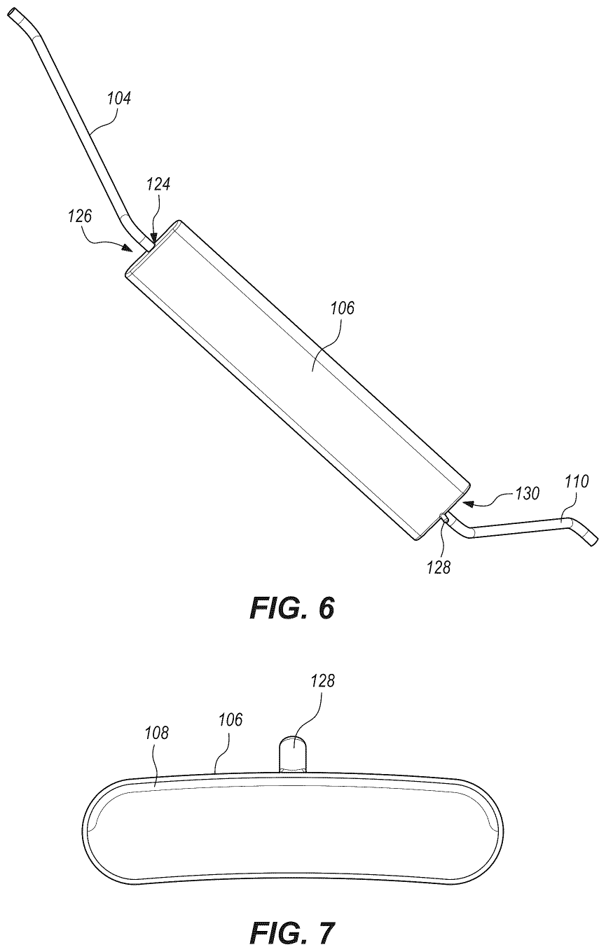

Referring to FIGS. 5-6, as saltwater enters the fluid inlet 122, it is deposited into the first trough 114 and flows into the plurality of receiving tubes 104. The plurality of receiving tubes 104 are also coupled to receiving apertures 124 on a top 126 of the plurality of housings 106. In a similar manner to the fluid inlet 122, the plurality of receiving tubes 104 may be a different shape, diameter, or both. The saltwater deposited into the plurality of receiving tubes 104 is eventually deposited into the plurality of housings 106, at a second position 125 that is radially distant to the shaft 102, via gravity and centrifugal force. The plurality of housings 106 may be vertically positioned, allowing gravity to induce the feed flow (flow of saltwater through the reverse osmosis centrifuge).

In some embodiments, the plurality of housings 106 may be stacked vertically to increase permeate production, while maintaining the same square footage. Further, in some embodiments, the plurality of housings 106 may have static turbines therebetween so as to drive feed flow. The plurality of housings 106 may be made of a fiberglass material that can compensate for pressure differential cycles during rotation, which creates better aerodynamics, structural resistance to a pressure differential, and vibration resistance. However, the plurality of housings 106 are not limited to fiberglass and may be other materials, such as aluminum, carbon fiber, plastic, etc.

In addition, the plurality of housings 106 may be a single unit that is seamless, airtight, and a smooth enclosure, thereby decreasing the windage effect. With the plurality of housings 106 being airtight, a body of air is sealed inside. At RPM, the body of air undergoes the same centrifugal and pressure gradient effects as the saltwater, forcing the air against the plurality of housings 106. If the plurality of housings 106 are not airtight, then unnecessary air consumption may occur. However, in some embodiments, the plurality of housings 106 may be multiple sealable components that may be removably attachable and adjustable.

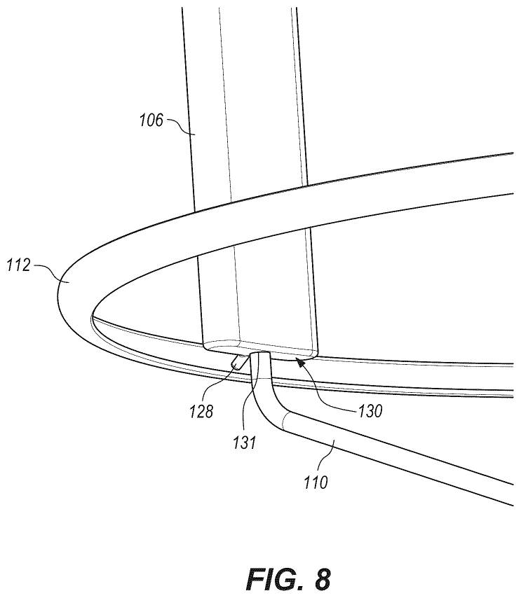

As shown in FIG. 7-8, the filter 108 may be positioned inside, and coupled to, the plurality of housings 106. The filter 108 may be coupled to the plurality of housings 106 with an attachment mechanism, such as glue. It should be noted that the filter 108 follows the contours of the plurality of housing 106. In other words, the curvature of the filter 108 and the inside of the plurality of housings 106 matches the curvature of the reverse osmosis centrifuge 100, which makes use of the pressure gradient effect. By compartmentalizing each filter 108 into an individual housing 106, centrifugal force can be easily transferred into the saltwater, rather than using a larger cylindrical filter known in the prior art. Centrifugal force creates pressure and pushes the saltwater into the filter 108. The saltwater flowing across the filter 108 becomes concentrate, while the salt water/feed flow is pressurized against the filter 108, and permeate is collected on the other side of the filter 108. The filter 108 may separate the concentrate and permeate flow paths. The filter 108 may be a graphene filter, a film composite membrane, a cellulose triacetate membrane, cellulose acetate, or any other type of filter. Further, the filter 108 may have fibers that are cylindrical, spiral, etc. It will be appreciated that the geometries of the filter 108 and the plurality of housings 106 allow the exact cross flow rate induced by gravity. In other words, the saltwater falls through the concentrate flow path in the filter 108 due to gravity. Because the first position 103 (centered at the axis) is in the highest position, and the second, radially distant position 125 (FIG. 4, distal end of the receiving tubes 104) is in a lower vertical position, gravity aids in the overall flow of the saltwater to the filter. Additionally, because the concentrate outlet is located at a third position 135, which is lower than both the first and second position 103, 125, respectively, gravity aids in the concentrate returning to the axis (shaft 102). However, a pump may also be used in some embodiments so as to increase the flow rate. The permeate is ejected through a permeate outlet 128, which is located at a bottom 130 (FIG. 8) of the plurality of housings 106, and into a permeate trough 112 where it may exit the reverse osmosis centrifuge 100.

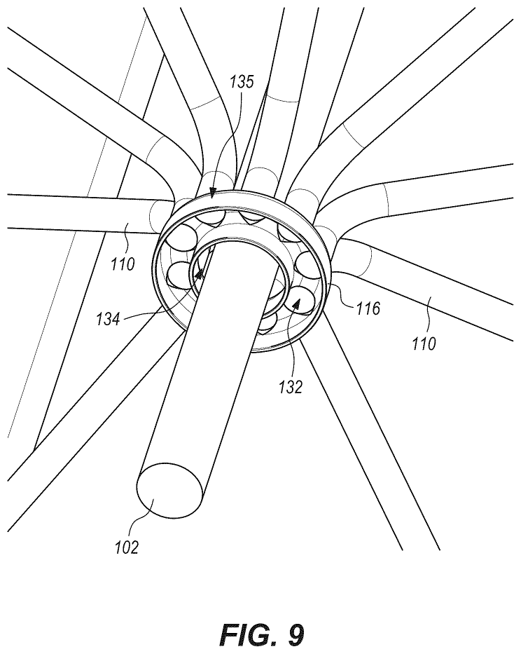

Referring to FIG. 9, while the permeate is deposited into the permeate trough 112, the concentrate is removed from the plurality of housings 106 by the plurality of departure tubes 110 that are coupled to the housings 106 by a plurality of departure apertures 131 (shown in FIG. 8). More specifically, the plurality of departure tubes 110 are coupled to the second trough 116 at a bottom of the reverse osmosis centrifuge 100, through a plurality of second apertures 132. The second trough 116 may also be coupled to the support shaft 102 via a second aperture 134, at a third position 135, which is vertically aligned with the first position 103. After the plurality of departure tubes 110 are coupled to the second trough 116, at the third position 135, the concentrate may exit therefrom. The plurality of departure tubes 110 may be a variety of shapes and sizes. In some embodiments, the diameter of the departure tubes 110 may be smaller in diameter than the diameter of the receiving tubes 104. This may be beneficial to aid in overcoming the loss of pressure due to the permeate that leaves the system. In other words, a smaller diameter departure tube 110 increases pressure to account for the pressure lost by the permeate, thereby bringing the system into equilibrium once again. Additionally, because the concentrate is denser than the incoming water in the receiving tubes 104, a higher pressure in the departure tubes 110 may be needed in some scenarios. Further, a pump may be utilized to increase the pressure in the departure tubes 110, either alone or in combination with smaller diameter departure tubes 110. Additionally, the angle of the plurality of departure tubes 110 may change depending on the dimensions of the reverse osmosis centrifuge 100.

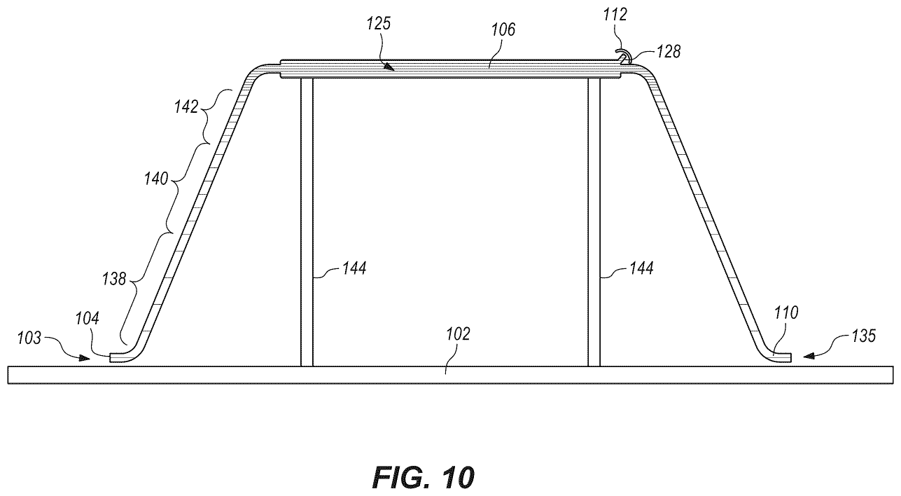

As shown in FIG. 10, the path of the feed flow resembles a “U” shape where the feed flow enters through the fluid inlet 122 at the first position 103. The flow path then gradually travels away from the first position 103, located on the vertical axis, to create more fluid pressure, where it reaches its max pressure at the plurality of housings 106 at the second position 125. The concentrate then gradually returns to center where it exits the plurality of departure tubes 110 at the second trough 116 at the third position 135 which is also located on the vertical axis. The objective of this geometry of the reverse osmosis centrifuge 100 is to maintain energy conservation in the feed flow. As the feed flow travels outward from the center, the centrifuge 100 adds energy to the fluid, which is manifested in a fluid velocity or centrifugal force. As the feed flow travels back towards the center, energy in the fluid is recovered through decreased velocity/centrifugal force, which aids in maintaining the rotation of the centrifuge 100. The necessary energy to drive the reverse osmosis centrifuge 100 is the difference between the quantities of feed flow traveling out versus in relative to the center of the reverse osmosis centrifuge 100. More specifically, when saltwater enters the plurality of receiving tubes 104, the saltwater is at a first, low pressure 138. As the saltwater travels down the plurality of receiving tubes 104, the pressure increases to a second, medium pressure 140 due to the rotational force. Lastly, after saltwater enters the plurality of housings 106, the saltwater is at a third, high pressure 142 (which occurs at second position 125) where it meets the filter 108 and is separated into two flow paths, permeate and concentrate. It will be appreciated that there is no mechanical wear or interfering surfaces in the high pressure region (second position 125) of the fluid, which may prevent wear on the reverse osmosis centrifuge 100. When the concentrate leaves the filter 108 and housing 106, it leaves in a reversed manner from how the saltwater entered. That is, from high pressure to low pressure as it is released via the plurality of departure tubes 110 at the third position 135. It should be noted that FIG. 10 illustrates an increase in pressure by the lines gradually becoming closer together as it moves away from the support shaft 102. In addition, referring to FIG. 10, the reverse osmosis centrifuge 100 may comprise support structures 144. The support structures 144 may be an aluminum, steel, or composite bracing. In some embodiments, the support structures 144 may be disks placed around the support shaft 102 and coupled to the plurality of housings 106. The support structures 144 may maintain the integrity of the apparatus when rotating so that the apparatus does not collapse or become otherwise damaged.

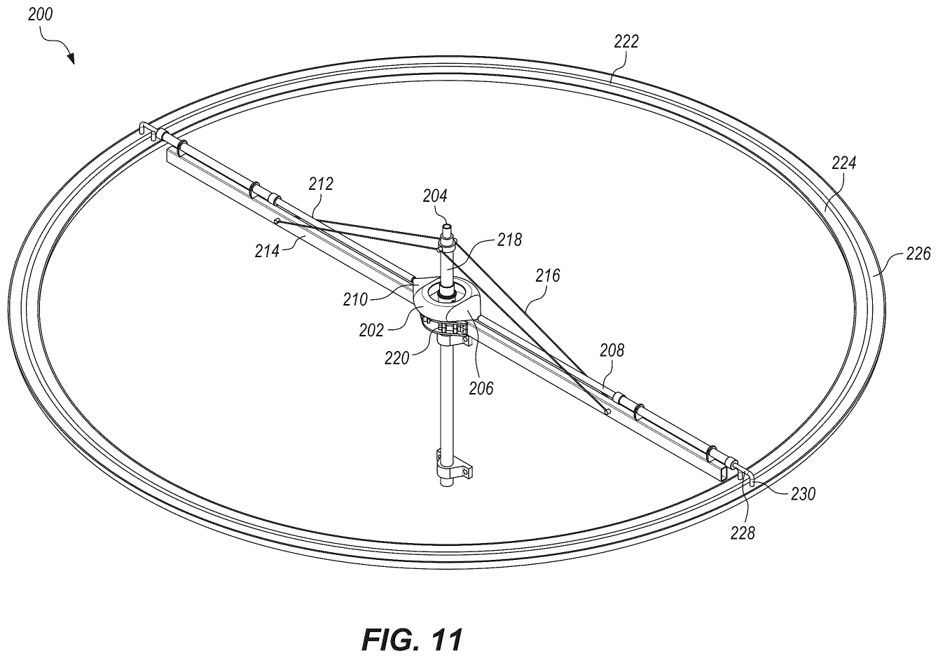

The reverse osmosis centrifuge 100 requires no energy recovery device because the process of recovering energy from the concentrate is an inherent function of the reverse osmosis centrifuge 100 because the concentrate returns to the axis. To show this effect, an equation that returns the torque necessary to rotate the device at a given diameter, RPM/pressure, and flow rate is shown. The formula is W=Q [Pgauge+(½)p(Q\hat{ }2/A\hat{ }2)+(½)p(w\hat{ }2)(r\hat{ }2). This equation is a simplified application of the first Law of Thermodynamics. For example, at a 36″ radius, 1097 rpm, 800 psi, and 6 gpm of flow, ˜4.15 kw is required for continuous rotation. At an 18″ radius, 3470 rpm, 2000 psi, and 20 gpm of flow, ˜33 kw is required for continuous rotation. The examples above illustrate the torque necessary assuming no energy recovery is used with the system, which means that the concentrate and permeate are being ejected at the circumference of the reverse osmosis centrifuge 100, similar to what is shown in FIG. 11 and discussed later herein.

However, by moving the concentrate back to the center of the reverse osmosis centrifuge 100 by utilizing departure tubes 110, pressure/velocity is converted back into rotational energy. To illustrate this effect, a simple modification can be made to the flow rate equation. As an example, and to show the effect of the concentrate moving toward the center, at a 36″ radius, there is 800 psi, 6 gpm of concentrate flow toward the filter, 0.25 gpm of permeate production, and 5.75 concentrate flow leaving the filter traveling back toward the radius. As long as the flow is moving outward, the flowrate is a positive number; if the flow is moving in the opposite direction, the flowrate is a negative number. For continuous rotation, ˜4.15 kw is required for 6 gpm flow, and ˜−3.97 kw is required for 5.75 gpm return flow. 4.15 kw-3.97 kw=˜0.18 kw (permeate energy consumption).

It should be noted that the difference between these two values is the energy required to produce the permeate. As shown and described above, the reverse osmosis centrifuge 100 only exhausts energy into the permeate production and none into the concentrate, which is a significant improvement over the prior art. In contrast, the prior art RO Trains exhaust energy into the permeate production and the concentrate, thus necessitating the use of an energy recovery device.

Further, the fluid pressure gradient is an inherent effect of the reverse osmosis centrifuge 100. At a given RPM, as fluid moves outward from the radius (i.e., axis), the fluid pressure increases. Pressure in the reverse osmosis centrifuge 100 is a function of the Specific Gravity of the solution, RPM, and the distance from the center of the axis. The following equation illustrates this relationship and the units are in Pa and Meters. The equation is PSI=5.4831(r\hat{ }2)(RPM\hat{ }2). As an example of how this equation is applied, at a 24″/0.6096 m radius, an RPM of 2708 is required to create 800 psi/5.5 MPA of fluid pressure. At a 96″/2.4384 m radius, an RPM of 411 is required to create 800 psi/5.5 MPA of fluid pressure. In the examples above, as the radius increases, the RPM necessary to create a given fluid pressure decreases, and as the radius decreases, the RPM must then increase. Those familiar with fluid dynamics will appreciate that there will be some variance in the formulas above due to temperature, viscosity, and other variables, but the above formulations illustrate the technology and may be adaptable to conditions by those in the art.

Therefore, in one method of use, saltwater enters the reverse osmosis centrifuge 100 at first position 103 located at the center, vertical axis (i.e., shaft 102). As the reverse osmosis centrifuge 100 rotates on the support shaft 102 (i.e., shaft 102 spins/rotates on its longitudinal axis), saltwater is forced radially outward through the plurality of receiving tubes 104. As the saltwater travels outwardly from the center, the water pressure increases and reaches its max pressure at the housings 106, located at a second position 125, containing the filter 108. The permeate then exits into the trough 112 and the concentrate returns to the center axis, at a third position 135, via departure tubes 110. Because the concentrate returns to center, its pressure is recovered prior to leaving the system. It will be appreciated that while receiving tubes 104 and departure tubes 110 are used as examples, other components (e.g., trays) and methods of moving water from a first, centered position, to a second, radially distant, position for filtering, and then returning concentrate to a third, centered position, may be used and do not depart herefrom.

In some embodiments, as shown in FIG. 11, a reverse osmosis centrifuge 200 comprises a substantially oblate spheroid housing 202 and water inlet 204. The housing 202 comprises a first funnel 206 coupled to a first outlet arm 208 and a second funnel 210 coupled to a second outlet arm 212. As a result, as the housing 202 spins, water is forced radially outward, where it is funneled through first funnel 206 and second funnel 210 to outlet arms 208, 212, respectively. As shown, the housing 202 and outlet arms 208, 212 may be supported by framework 214. Framework 214 may be supported using cables 216 that are coupled to center support 218. As appreciated, the support framework 214 spins with the housing 202. Again, water easily flows to the plurality of water outlets arms 208, 212 and pressure builds at the end of each arm due to rotational forces and the length of the arms 208, 212. Accordingly, the rotationally-induced pressure (which may be referred to as “centrifugal” force) provides for desalination at a lower energy cost since the rotational pressure is more easily sustained than traditional pump pressures. This is due to the use of bearings to aid in the rotation of the housing 202 and framework 214. In other words, the housing 202 and framework coupler 220 are able to rotate (i.e., spin) on the center support 218 through the use of bearings. Once the reverse osmosis centrifuge is spinning, it takes less energy to maintain the spinning than a traditional pump uses, particularly if high-quality, low friction bearings are used. As a result, pressure at the ends of arms 208, 212 is maintained with less energy input. Additionally, there is no mechanical wear or interfering surfaces in the high pressure region of the fluid. As water travels through each outlet arm 208, 212, pressure increases. Accordingly, a desalination membrane or filter is positioned toward the distal end of each outlet 208, 212 arm where pressure is the highest. The reverse osmosis centrifuge 200 may further comprise a trough 222 having a concentrate trough 224 and a permeate trough 226 for receiving the output from a concentrate outlet 228 and a freshwater outlet 230. As a result, the reverse osmosis centrifuge desalinates water at a reduced energy cost, which translates into a reduced monetary cost, making the desalinating technology more readily available. It should be noted that, as mentioned earlier, the reverse osmosis centrifuge 200 does not return the concentrate to center, and is therefore not as efficient as other embodiments described herein.

In some embodiments, a reverse osmosis centrifuge comprises a rotatable housing, having an oblate spheroid formfactor, having a water inlet and a plurality of water outlet arms. The rotatable housing is motor controlled so as to be easily rotatable (i.e., spinnable). As the rotatable housing spins, water in the rotatable housing is forced outward into the plurality of outlet arms. Each outlet arm extends radially from the rotatable housing. As water travels through each outlet arm, pressure increases. Accordingly, a desalination membrane or filter is positioned toward the distal end of each outlet arm where pressure is the highest. As a result, of the pressurized separation, concentrate exits a concentrate outlet and permeate exits the permeate outlets. The reverse osmosis centrifuge further comprises a trough for receiving the output from the concentrate outlets and permeate outlets, the trough divided into a concentrate trough and permeate trough so as to ensure separation of the permeate from the concentrate. The concentrate trough having a concentrate outlet and the permeate trough having a permeate outlet. In some embodiments, the concentrate trough is located near the axis of rotation.

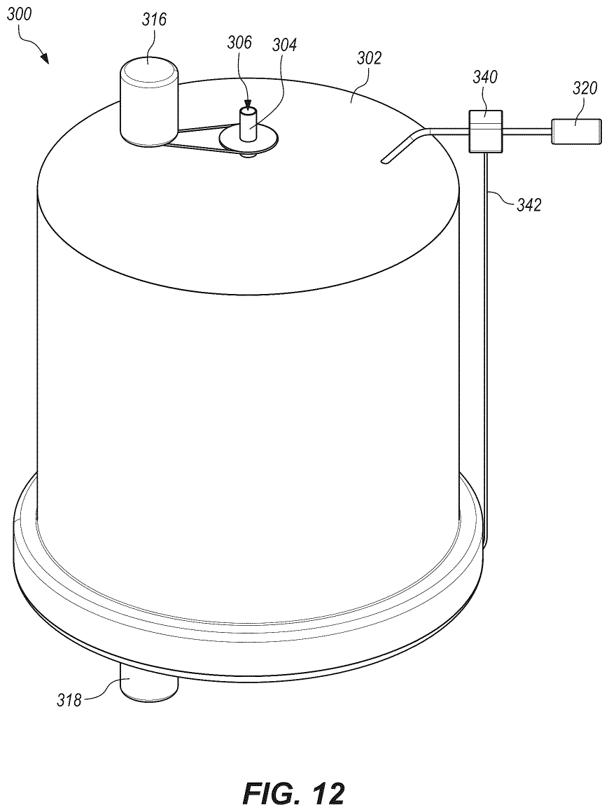

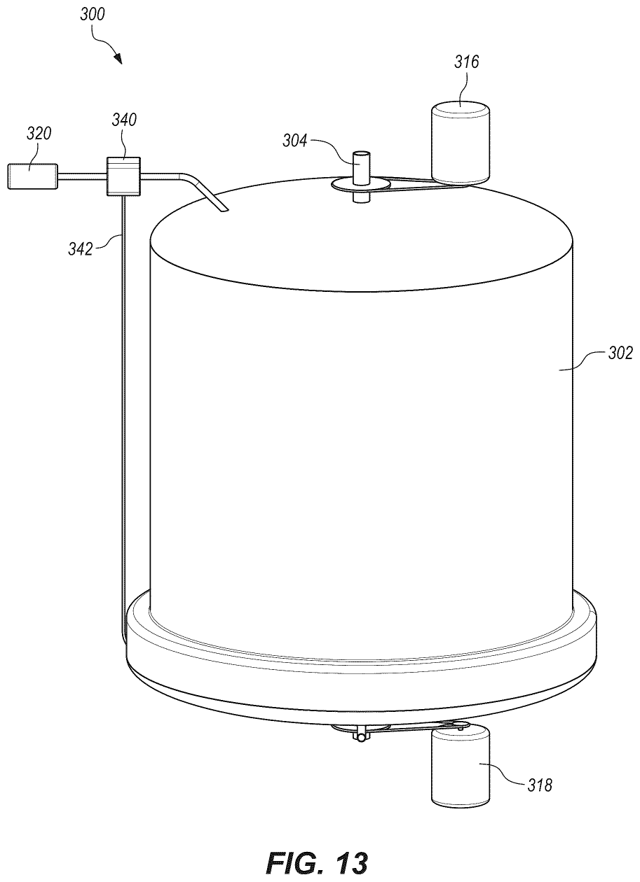

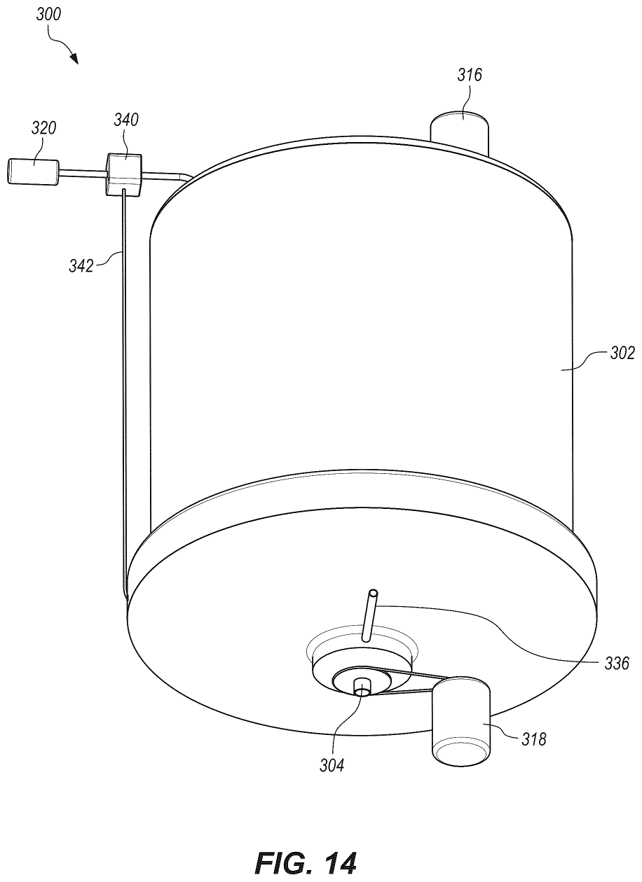

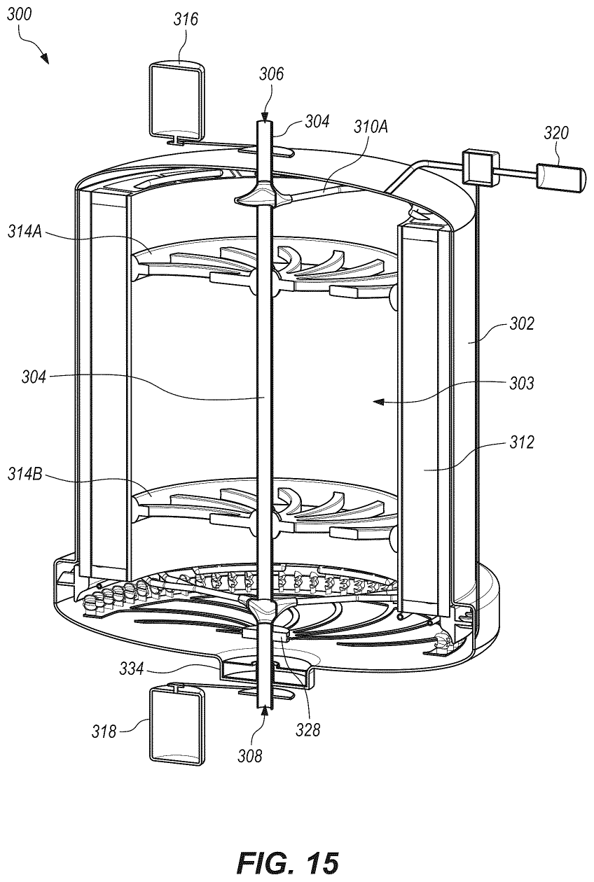

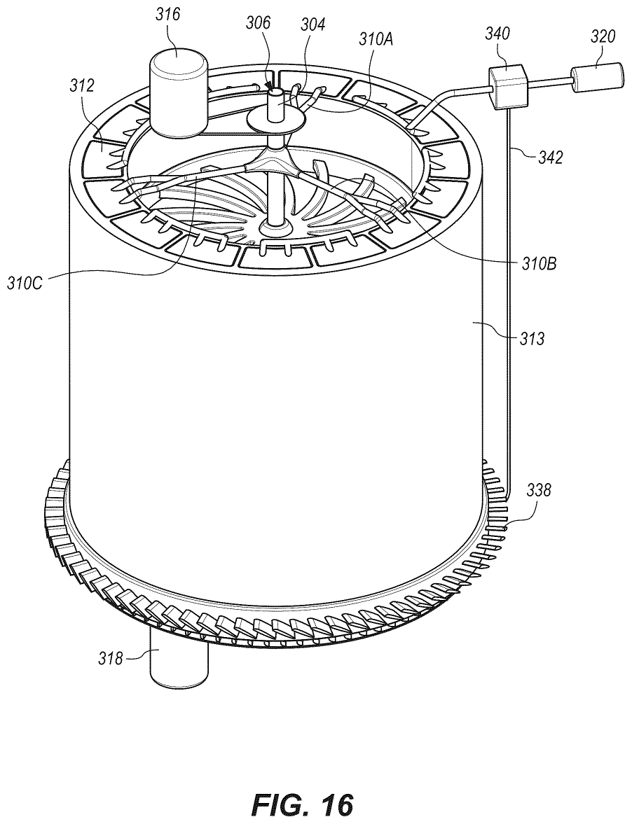

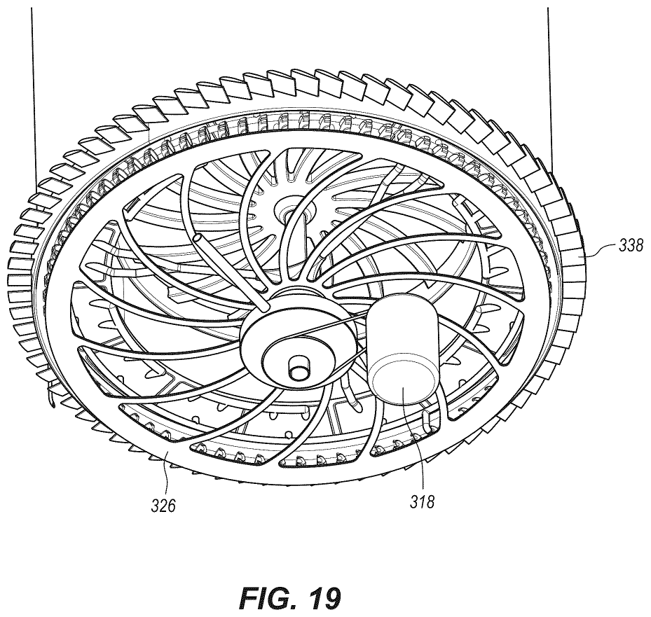

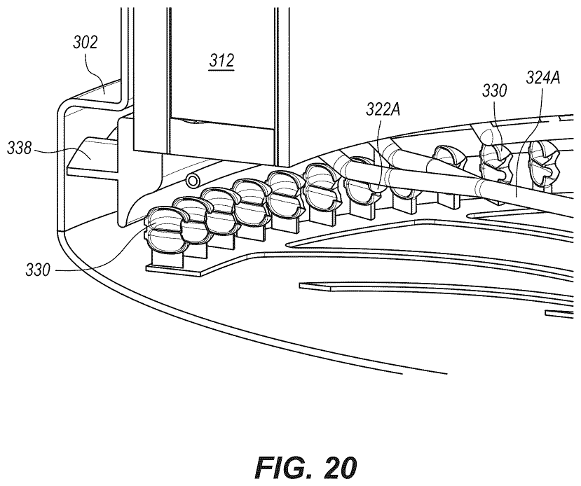

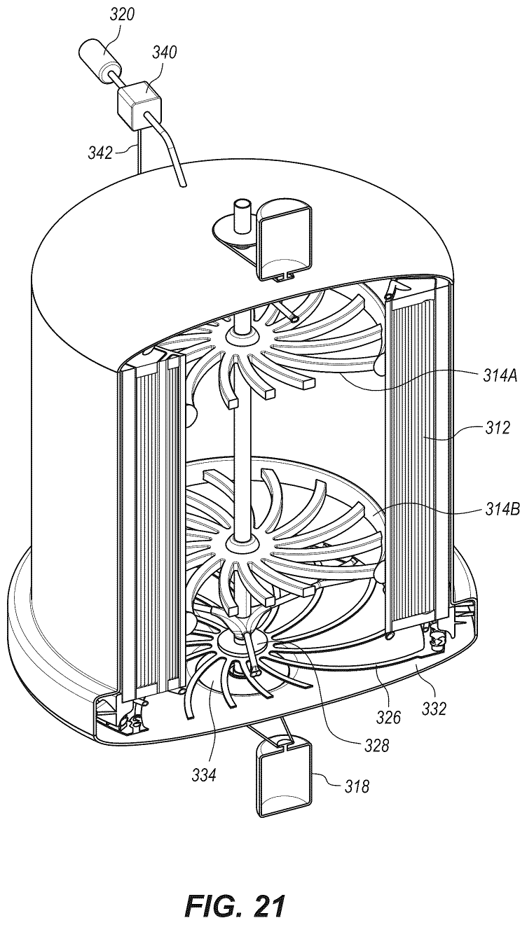

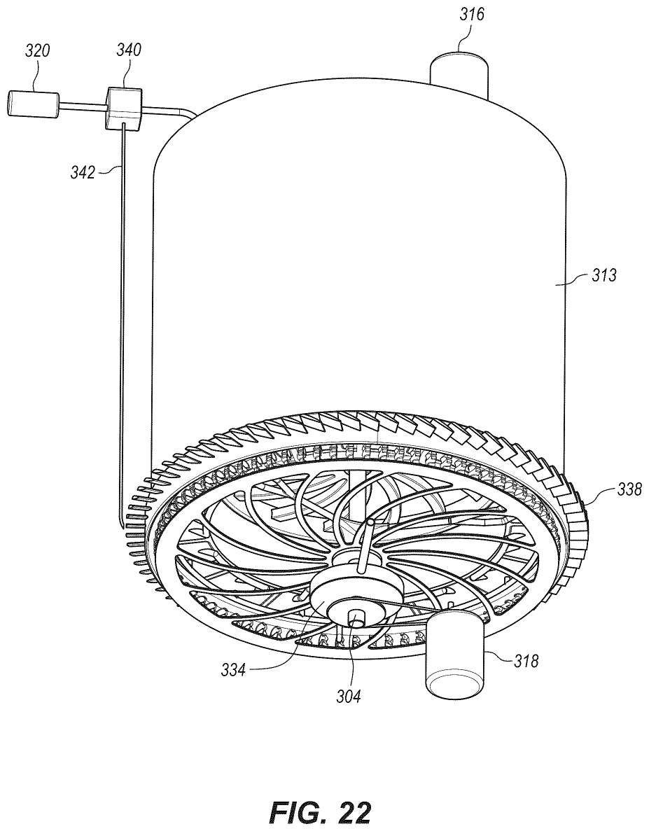

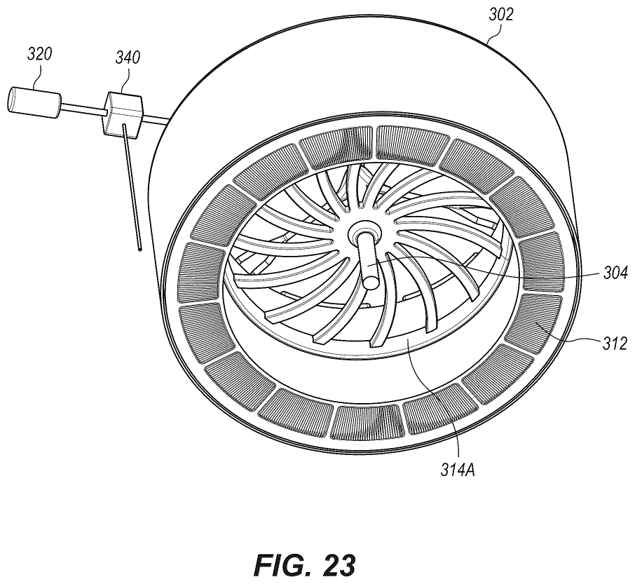

In some embodiments, as shown in FIGS. 12-23 a reverse osmosis centrifuge 300 comprises a stationary cylindrical housing 302 with a driveshaft 304 extending longitudinally through the cylindrical housing 302. In some embodiments, the cylindrical housing 302 is sealed so as to create a vacuum chamber 303. The driveshaft 304 is configured to rotate freely, and may be sealed with the cylindrical housing 302 using a rotary union seal or other seal known in the art. The driveshaft 304 comprises a water inlet 306 at a first end and a concentrate outlet 308 at a second, opposite end. Saltwater enters through the water inlet 306 where it descends into a plurality of receiving tubes 310A-C coupled to the driveshaft 304. The receiving tubes 310A-C extend radially from the driveshaft 304 and carry saltwater from the water inlet 306 to a plurality of vertical desalination membranes 312 configured to separate freshwater from saltwater. The vertical desalination membranes 312 configured in a membrane cylinder 313 sized so as to be rotatable within the stationary cylindrical housing 302.

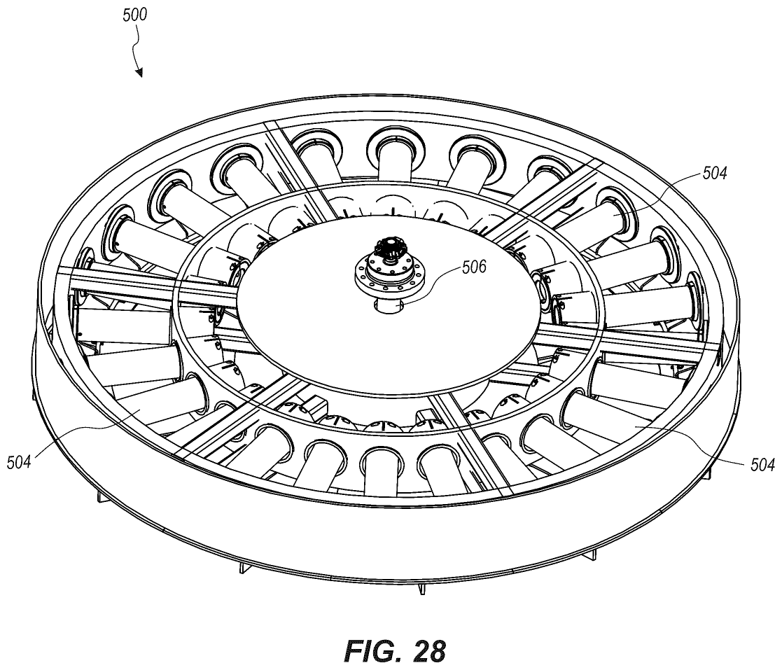

The traditional reverse osmosis membrane design resembles a spiral-wound sheet. Spiral-wound membranes are not designed to be subjected to significant centripetal accelerations (or G-Forces), but are designed to operate in a static environment. In typical reverse osmosis applications, concentration polarization is where the heavier particles, like salts and crystals, collect on the surface of the membrane where the filtration occurs. Once the membrane pores are clogged, the membrane fouls, and less freshwater is produced. In a centrifugal environment, the concentration polarization is more likely to occur on the surfaces that face the axis of rotation, rather than the membrane surfaces. If the membranes are oriented in a way where the membrane element extends radially from the axis of rotation, where the membrane elements are perpendicular to the axis of rotation (FIG. 28), an increase in permeate production could yield. This orientation would allow for the lower concentration solution to be positioned inward relative to the higher concentration solution. If the membranes are exclusively exposed to the lower concentration solution, higher permeate production can occur. This can be described as a “scouring” effect, which causes the heavier particles to be pulled away from the membrane element, thus concentrating on the outer wall of the housing.

The desalination membranes 312 are coupled to the driveshaft 304 via one or more support arms 314A-B. As a result, as the driveshaft 304 rotates, the plurality of desalination membranes 312 likewise rotate inside of the cylindrical housing 302. In some embodiments, a first motor 316 is coupled to a first end of the driveshaft 304 to rotate the driveshaft 304. In addition thereto, or in the alternate, a second motor 318 may be coupled to the driveshaft 304 at a second end.

In some embodiments, a vacuum pump 320 applies a vacuum to the internal vacuum chamber 303 of the cylindrical housing 302. A vacuum chamber 303 reduces windage and other oppositional forces, allowing the rotor-like components (i.e., driveshaft 304 coupled to desalination membranes 312) greater spinning efficiency. As a result, the motors 316, 318 require less energy to achieve a desired RPM. The energy required by the vacuum pump 320 is less than the energy required by the motors 316, 318 to overcome windage and drag, resulting in greater efficiency. If the level of vacuum is too high, the water can potentially boil at room temperature. The boiling point of water decreases as the vacuum increases. The vacuum chamber 303 and vacuum pump 320 maintains a partial vacuum to keep water in a liquid state while passing through the evacuated enclosure.

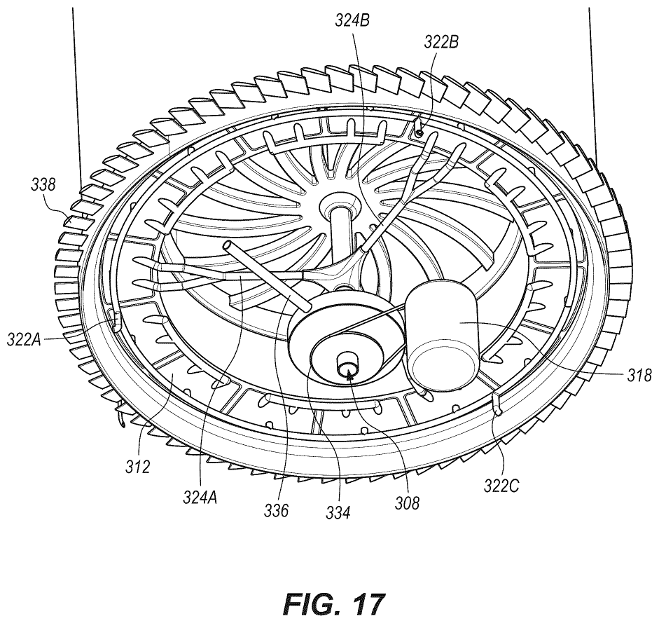

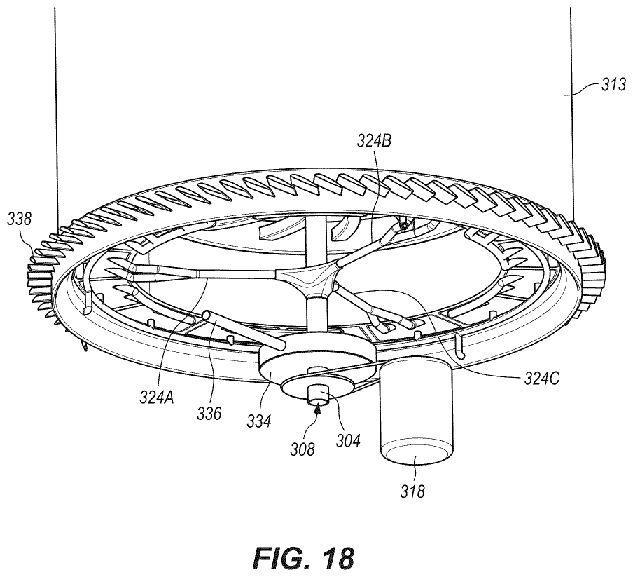

Saltwater is fed into the vertical desalination membranes 312 via the water inlet 306 and receiving tubes 310A-C. The rotational forces created by motors 316, 318 force the water outwardly into the desalination membranes 312. Pressure and gravity then force the saltwater through the vertical desalination membranes 312, where freshwater is separated from salt concentrate. The freshwater (permeate) exits through a plurality of freshwater outlets 322A-C (best seen in FIG. 17) at the bottom of the desalination membranes 312 and saltwater concentrate (brine) travels from the desalination membranes 312 to the concentrate outlet 308 via a plurality of concentrate departure tubes 324A-C (best seen in FIG. 18) that couple to the concentrate outlet 308.

In order to create the pressure required for desalination, the membrane cylinder 313 has to reach nominal RPM where the angular velocity of the water ejected from the membrane cylinder 313 can be up to 400 mph. Up to fifty percent of the energy exerted into freshwater production takes the form of this velocity. If a turbine is positioned to be driven by this water, a significant amount of energy can be recovered from the system. Accordingly, in some embodiments, an energy recovery turbine 326 is positioned below the freshwater outlets 322-A-C and is configured to spin independently of the driveshaft 304, such as by using bearings to couple it to the driveshaft 304. As freshwater exits the freshwater outlets 322A-C, the force of the water spins the energy recovery turbine 326. The energy recovery turbine 326 is geared to the driveshaft 304 via one or more gears 328, where it rotates at a fixed, reduced speed. As a result of this recapture of energy, the total energy lost in the system is reduced, resulting in higher efficiency. In some embodiments, the energy recovery turbine is coupled to an alternator to produce electricity, which may then be fed to the second motor 318. In some embodiments, the energy recovery turbine 326 comprises a plurality of cup-shaped blades 330 to receive the freshwater and induce spinning easier.

The freshwater is then collected at the bottom basin area 332 of the cylindrical housing 302 (within the vacuum chamber 303). From there, a freshwater pump 334 (e.g., sump pump) may pump the freshwater out via a freshwater line 336 (FIG. 17).

An inevitable effect of the partial vacuum environment in the vacuum chamber 303 is the accumulation of water vapors in the air. This can happen naturally due to evaporation (which accelerates as a function of the vacuum) or due to the mechanical misting of the water as it is pumped out of the membrane cylinder 313. Vapors in the air can negatively affect the performance of the vacuum pump 320. If moisture in the vacuum chamber 303 is not collected before the vacuum pump 320, the moisture will bind with the lubricating oil, and accelerate the wear. Accordingly, referring back to the vacuum aspects, a vapor turbine 338 is coupled to the exterior of the desalination membranes 312 and spins therewith. As a result, as water vapor from the basin area 332 attempts to rise, it is deflected by the vapor turbine 338, thereby reducing or preventing water vapor from entering into the vacuum pump. In some embodiments, a condenser 340 (e.g., condensing coil) is interposed between the vacuum pump 320 and the vacuum chamber 303 of the cylindrical housing 302, thereby condensing any water vapor before it enters the vacuum pump 320 and redirecting any resulting water back into the vacuum chamber 303 via condenser line 342. By preventing water from entering the vacuum pump 320, the components of the reverse osmosis centrifuge 300 will work properly and will be less prone to failure. In some embodiments, a wet lap seal or other seal may be used to prevent moisture from reaching the vacuum pump 320. In some embodiments, the condenser 340 may be replaced with a centrifugal coalescing filter to reduce moisture saturation of the atmosphere in the vacuum chamber 303. Air is directed through the centrifugal coalescing filter where dried gas exits through an inboard radial position. The dried air then enters the vacuum pump 320 where it is pumped out of the chamber to the atmosphere. The remaining liquid water condenses and collects in the bottom basin area 332.

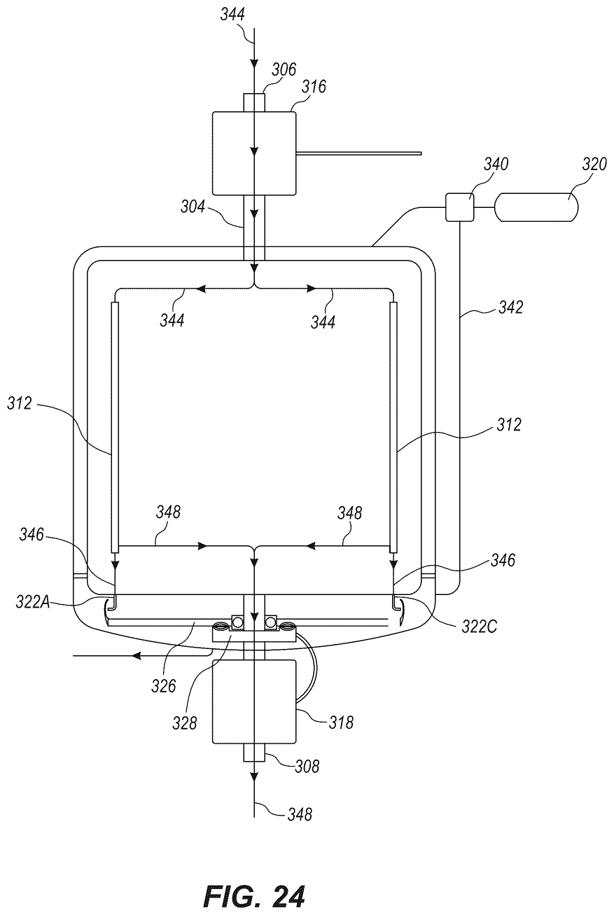

In one method of use, a user would start the first motor 316 and/or the second motor 318 to begin rotating the driveshaft 304 and the components coupled thereto, including the vertical desalination membranes 312 and vapor turbine 338. As shown in FIG. 24, saltwater 344 is directed into the inlet 306 where gravity and radial forces feed the saltwater 344 into the vertical desalination membranes 312 where the saltwater 344 is separated into freshwater 346 and salt concentrate 348. It will be appreciated that the centrifugal force provides for the pressure required to attain the separation of saltwater 344 into freshwater 346 and concentrate 348 and results in less energy required by the motors 316, 318. As freshwater 346 is ejected out of the freshwater outlets 322A-C, the water makes contact with, and spins, the energy recovery turbine 326. The mechanical energy from the energy recovery turbine 326 is converted to electrical energy, such as via the alternator, where the electricity is then supplied to one of the motors 316, 318, or mechanical energy via a gear train 328. By recapturing energy from the energy recovery turbine 326, less energy is required to continue processing water, increasing efficiency and reducing cost. The salt concentrate 348 flows back to the center axis (i.e., driveshaft 304) via concentrate departure tubes 324A-C (not shown in this diagram), where it exits the concentrate outlet 308. By returning the salt concentrate 348 to the center axis, less energy is lost, allowing the vertical desalination membranes 312 to spin faster with less energy consumption.

In other words, by utilizing centrifugal forces, vacuum chambers, vapor suppression technology, and permeate and concentrate energy recovery components, the reverse osmosis centrifuge 300 is capable of desalinating water using less energy input than desalination systems of the prior art.

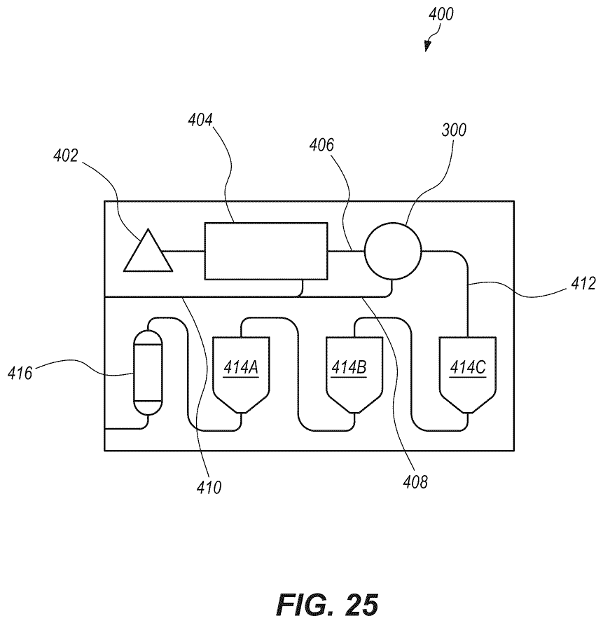

In some embodiments, as shown in FIG. 25, a system for desalination 400 comprises a feed 402 for a non-centrifugal reverse osmosis system 404 (or other known desalination system of the prior art) and at least one reverse osmosis centrifuge 300 coupled to the waste stream 406 of the reverse osmosis system 404. While waste stream 406 is used as an example, other streams may be used, such as a brine stream, a reject stream, or some combination of streams. Accordingly, the non-centrifugal reverse osmosis system 404 may have a waste stream, a brine stream, a reject stream, or multiple streams. Returning to the reverse osmosis centrifuge 300, this placement allows the reverse osmosis centrifuge 300 to add pressure to the static pressure of the waste stream 406 (or other stream), thus increasing pressure and recovery efficiently. In the system 404, the hydraulic connection between the membranes and the pressure exchangers is pressurized by the main feed pump of the plant, which can vary based on salt concentration. By attaching the reverse osmosis centrifuge 300 to this hydraulic line, the static pressure of the reverse osmosis centrifuge 300 matches the system pressure of the non-centrifugal reverse osmosis system 404. When the reverse osmosis centrifuge 300 is at nominal RPM, the operating pressure equals the sum of the pressure generated by the non-centrifugal reverse osmosis system 404 and the centripetal accelerations generated by the reverse osmosis centrifuge 300. For example, if the static pressure of the non-centrifugal reverse osmosis system 404 is 800 psi, and the reverse osmosis centrifuge 300 generates an additional 800 psi, the new process pressure will be 1600 psi. An additional benefit of this configuration is the waste stream pressure matches the pressure at the inlet (minus the head loss of the reverse osmosis centrifuge 300). This allows downstream devices to operate under the same conditions prior to the placement of the reverse osmosis centrifuge 300.

The freshwater stream 408 from the reverse osmosis centrifuge 300 is combined with the freshwater stream 410 of the reverse osmosis system 404. The waste stream 412 (e.g., salt concentrate/brine solution) exits the reverse osmosis centrifuge 300 and is collected in one or more holding tanks 414A-C. In some embodiments, a separator 416 utilizes Molecular Recognition Technology to separate and collect desired elements from the waste stream 412. Because the waste stream 412 volume is minimized as a result of the reverse osmosis centrifuge 300, the economics of using Molecular Recognition Technology (MRT) for “brine mining” are viable.

For example, brine mining comprises inserting desired MRT molecules into multiple holding tanks to bind with a desired element/ion. Water continuously flows through each holding tank and is stripped of the desired elements via the MRT molecules. As the molecules bind with each other, more MRT molecules must be added so that more wastewater entering the system can be processed. This can be done via an automated dosing system. Once a certain number of molecules have been bound in a given tank, solvent extraction, ion resin exchange, or precipitation can be used to harvest the materials.

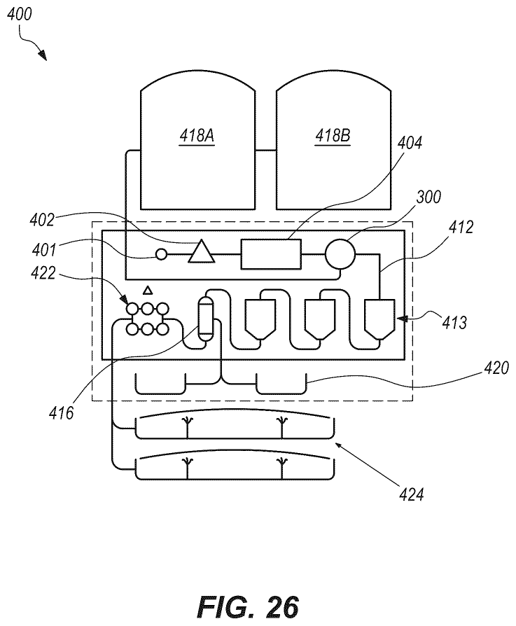

As shown in FIG. 26, the system for desalination 400 may further comprise one or more freshwater holding tanks 418A-B. For example, a water source 401 may be pretreated at 402 before entering a non-centrifugal reverse osmosis system 404 and then the reverse osmosis centrifuge 300. Additionally, the waste stream 412 passes from at least one reverse osmosis centrifuge 300 through the holding tanks configured as a series 413, and a separator 416 (e.g., cartridge filter). As described earlier, MRT may be utilized as the waste stream 412 flows through the series 413 (e.g., tanks 414A-C) and separator 416, where elements (e.g., heavy metal ions) may be extracted. Toxic substances flow into toxic ponds 420 from the separator 416. The permeate from the separator 416 then goes through an ion-resin exchanger 422. From there, any resulting freshwater is redirected to the holding tanks 418A-B with the remaining solution being redirected to one or more collection ponds 424.

By coupling at least one reverse osmosis centrifuge 300 to a prior art desalination system 404, the efficiency of the desalination is greatly increased with little additional energy consumption. This is extremely beneficial for desalination plants that may not have additional space or energy for expanding with traditional desalination systems of the prior art. In contrast, a desalination plant may integrate a reverse osmosis centrifuge 300 to their current system with little impact, overcoming problems in the prior art. In some embodiments, a system may comprise a plurality of reverse osmosis centrifuges 300. If connected in parallel, redundancy is ensured. In some embodiments, the reverse osmosis centrifuge 300 treats water ranging from 35,000 total dissolved solids (TDS) to 250,000 TDS.

The design of an “off the shelf” spiral wound membrane element must be considered when designing a reverse osmosis centrifuge. The size of the centrifuge must scale and increase along the axis of rotation, which suggests a vertical membrane orientation to be suitable. This orientation, however, may increase the negative effects of concentration polarization on the membrane surfaces facing the axis of rotation. In other words, the heavier salt particles are drawn to the outer radial positions and collect on the membrane surfaces or housing walls. On these membrane surfaces, permeate production may be reduced by up to 95%.

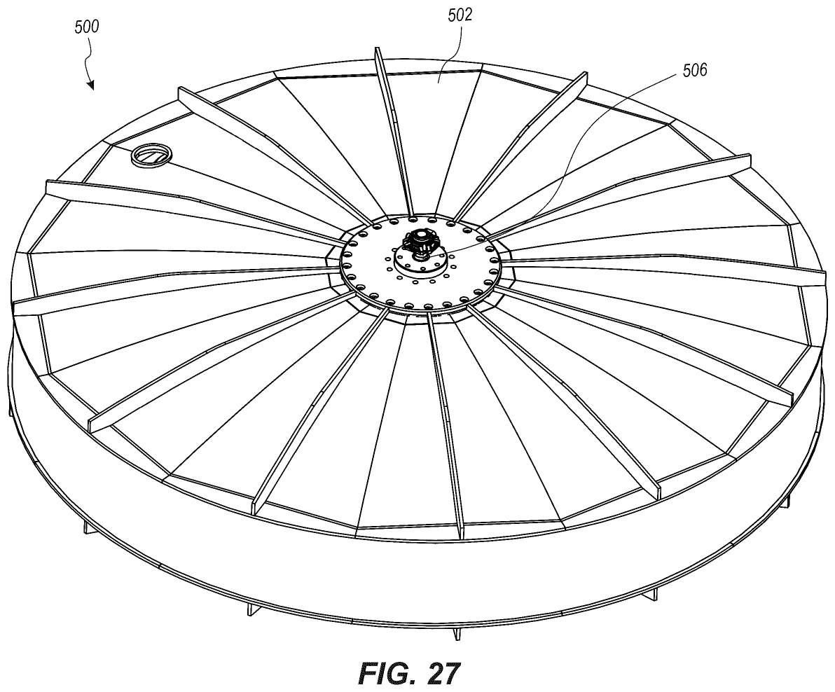

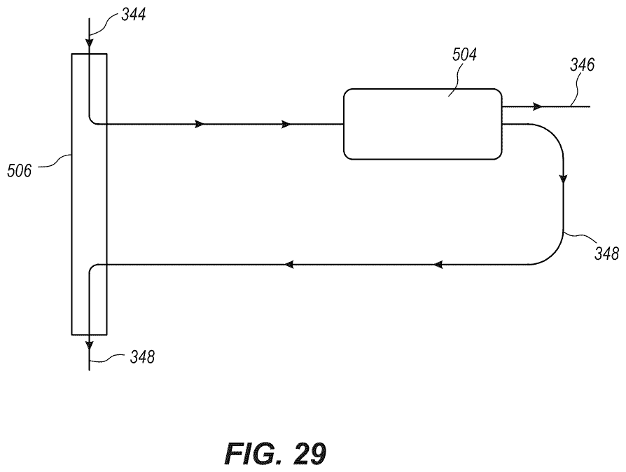

Therefore, in some embodiments, by adopting a horizontal orientation for the membranes, as illustrated in FIGS. 27-29, the effects of centrifugal force on the salt particles can be made a beneficial effect. For example, in some embodiments, a reverse osmosis centrifuge 500 comprises a housing 502 (forming a vacuum chamber) having a plurality of desalination membranes 504 that extend radially from the axis of rotation of a driveshaft 506. As a result, the heavier “fouling” particles are drawn from the membrane surface into the concentrate stream. This principle allows for the recovery of the overall reverse osmosis process to be greatly increased. In this orientation, the membranes 504 are also much more resilient to the effects of centrifugal forces. It will be appreciated that this embodiment comprises components disclosed in other embodiments, although they may not be visible and labeled. FIG. 29 illustrates the flow of saltwater 344 into the axis of rotation, where it follows centrifugal forces radially outwardly to the membranes 504, where the saltwater 344 is separated into freshwater 346 and concentrate 348, the concentrate being returned to the axis of rotation to recover energy.

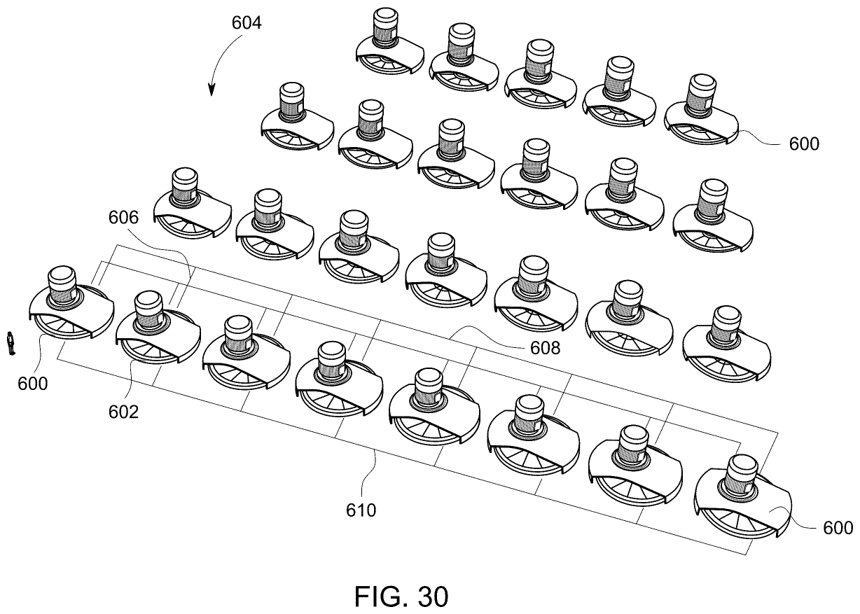

As illustrated in FIG. 30, one or more centrifuge assemblies 600 may be used in conjunction as part of a desalination plant. The assemblies 600 may be established in a spaced array 604 to provide for greater desalination than a single centrifuge can supply. Each assembly 600 may be placed in a safety enclosure 602. The array 604 of assemblies 600 may allow for use of one or more pipes 606 as a combined feed for salinated water. In addition, the array of assemblies 604 may use one or more pipes 608 as a combined outlet for fresh water as well as one or more pipes 610 as a combined outlet for reject fluid. Combined power supply, construction, and other support functions may allow the array 604 to produce a required quantity of fresh water while allowing the ability to scale each centrifugal assembly 600 to an optimum size.

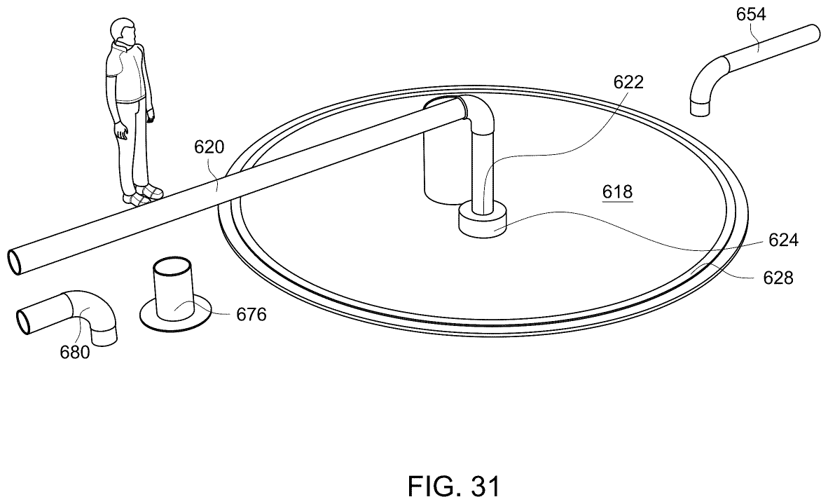

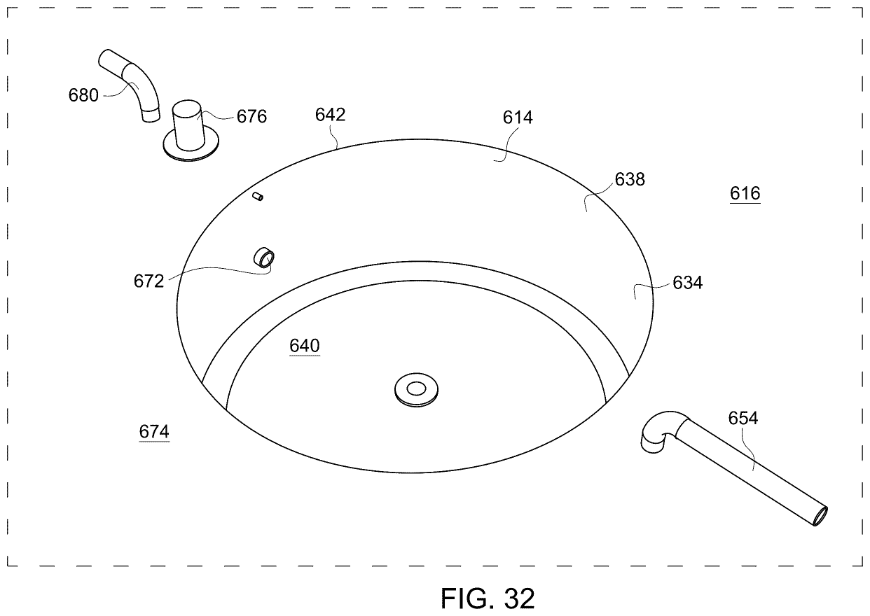

As illustrated in FIGS. 31-33, embodiments of the centrifuge assembly may comprise a centrifuge 632 positioned in an enclosure 614 recessed below a ground level 616 of a support structure 674. The enclosure 614 may be a safety enclosure that includes a variety of advantages, including reducing injury from accidental mechanical failure, stabilizing temperature, improving space efficiency, lowering the cost associated with supporting the centrifuges weight and operation, and negating vibration. The enclosure 614 may be excavated by digging, drilling, or otherwise. The enclosure may be also be formed by building up a surrounding ground level to form the support structure 674. As such ground level indicates an upper level below which the enclosures are recessed, but the ground level may be above or below any surface level surround the enclosure or array of enclosures. The enclosure 614 may comprise a cylindrical wall 634 that extends into the support structure 674, which may comprise earth, concrete, or other appropriate materials.

The enclosure 614 may comprise a cylindrical wall 638. The cylindrical wall may extend from a lower surface 640 of the enclosure to an open end 642 of the enclosure. The cylindrical wall may comprise a sidewall liner 644. The sidewall liner may have an upper flange 626. The upper flange may project outwardly from the open end 642 of the cylindrical wall 638. The sidewall liner may also comprise a lower flange 646. The lower flange may project inwardly from a lower end of the cylindrical wall adjacent to the enclosure lower surface 640.

The cavity 614 may comprise a lid 618 that covers the cavity. A feed fluid inlet pipe 620 may extend through a central opening 622 in the lid 618. A collar 624 may round the inlet pipe 620 and secure the pipe to the lid 618 and the enclosed centrifuge. The lid 618 may comprise a flanged surface 628 extending around the circumference of the lid. The lid 618 may also support a drive motor 630 that provides drive for rotating the centrifuge 632 positioned in the enclosure 614. The lid 618 may extend downwardly from the lid edge to the lid central opening 622 such that the lid is higher at is circumference 650 than in a central region 652.

The flanged surface 628 may be secured around the lid circumference. The flanged surface may be secured to the liner 644 upper flange 626. The flanged surface may be secured by bolts, or it may be secured by welding, riveting, adhesive, or other appropriate means as would be understood by one of ordinary skill in the art. The lid may be secured in such a way that it can be sealed and maintain a level of vacuum in the enclosure relative to the ambient air above the lid.

The cavity 614 may comprise a bottom liner 648. The bottom liner may cover the lower surface 640 of the enclosure 614. The lower surface may be supported by base portion 636 of the support structure 674. A reject fluid outlet pipe 654 may extend through the bottom liner 648 at the center 656 of the lower surface 640 of the enclosure 614. The reject fluid pipe 654 may extend below the lower surface of the enclosure for some horizontal distance 658 then vertically parallel to the enclosure cylindrical 638 for some vertical distance 660 after which it exits at the ground level 616.

The lower surface 640 of the enclosure may extend upwardly from an area 662 adjacent to the sidewall 638 toward the center 656 of the lower surface such that the lower surface is higher at the center than adjacent the sidewall. The center 656 of the lower surface 640 of the enclosure 614 may support a bearing foot 664. The bearing foot may support an axle 666 of the centrifuge 632 for rotation of a centrifuge rotor 633 about a central axis of the enclosure. The axle 666 may extend from the bearing foot 664 at the lower surface to the collar 624 at a center opening 622 of the lid.

A fresh water collection conduit or pipe 668 may extend from an opening 672 in the cylindrical wall 638 of the enclosure. The collection pipe 668 may extend through the sidewall liner 644. The collection pipe 668 may extend from the enclosure 614 to a fresh water sump 670 positioned in the support structure 674 spaced from the enclosure 614. The sump 670 may comprise an opening 678 at upper end adjacent the ground level 616 of the support structure 674. A fresh water pump may be positioned at least partly within the fresh water sump 670 with a pump motor 676 adjacent to the opening 678. The motor 676 may at least partially cover the opening 678. A fresh water outlet 680 may extend through the support structure 674 from a first end 682 adjacent to a lower end 684 of the fresh water sump 670 to a second end 686 that extends above the ground level 616.

Embodiments of the centrifuge assembly may comprise strain gauge, accelerometer, revolution per minute (“RPM”), and flow sensors on dynamic and static components. Strain gauges may be used to measure the rotor stresses during operation. Any deviation from a normal trend of stress values can indicate structural failure in a variety of manners.

By accounting for rotor stresses, along with RPM, all fluid flow rates, and general vibrations, embodiments of the centrifuge assembly may be fully automated, and critical information can be alerted to a system operator. A complex sensor array may provide advantages in ensuring reduced maintenance costs and system reliability/safety. A sensor array may be advantageous in ensuring an array of centrifuge assemblies meets operator requirements by ensuring rotor integrity, filter integrity, and product water quality. Embodiments of a sensor array may also ensure safety of product water quality. If hazardous or damaging material, such as an oil spill, was brought into the desalination plant and pumped into the centrifuge, detection would be immediate and product water quality could be ensured. Embodiments of a sensor array may allow operators to develop maintenance schedules.

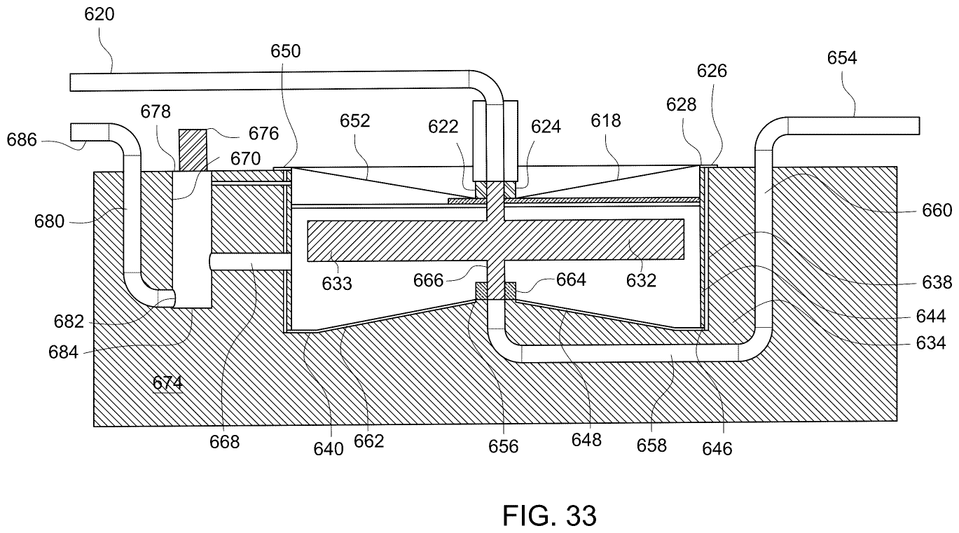

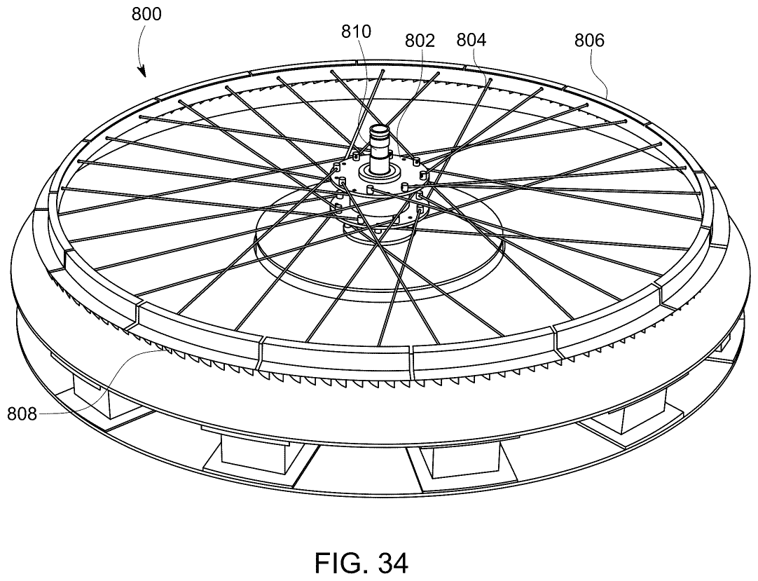

As illustrated in FIG. 34, embodiments of a centrifuge assembly may comprise a permeate recovery turbine 800. The recovery turbine may comprise a central hub 802 with spokes 804 extending from the central hub 802 to an outer rim 806. The outer rim may comprise turbine blades 808 extending from a surface of the outer rim. An axle 810 of the recovery turbine may extend coaxially with or be integrally formed with an axle of a centrifuge (e.g., axle 666, FIG. 33). The recovery turbine 800 may rotate at a fixed that is a slower speed than an operational speed of the centrifuge rotor. Embodiments of a recovery turbine employing a central hub, spokes, and outer rim as described herein may provide advantages, including reducing the weight of the turbine in comparison to the centrifuge rotor. Embodiments as described serve to translate torque to the center hub and carry the turbine blades. Embodiments as described may be light weight and, accordingly, reduce bearing and lubrication requirements.

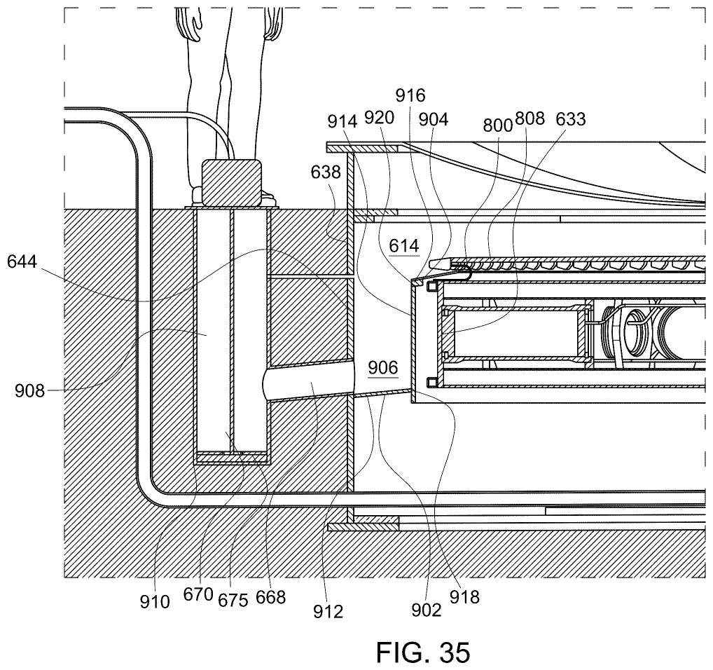

As illustrated in FIG. 35, embodiments of the centrifuge assembly comprise a static annulus 902 that is connect with the cylindrical wall 638 and/or sidewall liner 644 of the enclosure 614. The annulus 902 extends from the wall 638 to an end point 904 in close proximity with the centrifuge rotor 633 and permeate turbine 800. The annulus extends around the circumference of the rotor and turbine and forms a collection area 906 that feeds through a collection pipe 668 to a fresh water sump 670. The annulus may comprise a relatively horizontal, first section 912 that extends from the wall 638 at an angle less than 45°. A relatively vertical, second section 914 may extend upwardly from an inside end 918 of the first section. The second section may extend from the first section at angle greater than 45°. The second section may form a generally cylindrical portion surrounding at least part of the centrifuge rotor 633. A lip 916 may extend inwardly from an upper end 920 of the second section 914.

The annulus end point 904 may be positioned under the turbine blades 808 of the recovery turbine 800 and, via gravity, collect the fresh water as it is ejected from the turbine blades. The annulus 902 may act like a funnel and direct water to the adjacent sump column 908, where a low energy pump 675 is positioned at its base 910. Considering that the sump may be exposed to moderate vacuum pressure, the column 908 allows head potential to be developed in the water column above the pump, therefore preventing cavitation, which may otherwise occur due to the negative pressure of the vacuum enclosure. The pump 675 drives the water through a check valve back to atmospheric pressure and adds any extra pressure required to drive the freshwater through the permeate collection system of the plant. A larger booster pump may be employed to receive permeate water from each centrifuge assembly and boost its pressure in a more uniform manner.

Embodiments of the centrifuge assemblies may incorporate different materials as appropriate for each component. In embodiments of the centrifuge assemblies, Super Duplex 2507 may be used for all fluid carrying components, including the axle. This alloy provides particular advantages over the use of stainless steel for centrifuge components as known in the art, including its ability to handle the corrosive environment of the centrifuge and not yield to its high forces.

In addition, embodiments of the centrifuge assemblies may use STRENX carbon steel for the centrifuge rotor structure. This material provides advantages due to its affordable price and superior strength to weight ratio. Alternatively, carbon fiber composites may be substituted for this material in certain components. Carbon fiber will provide distinct advantages for larger centrifuge assemblies due to its high tensile strength and low weight. This material may diminish bearing losses, in part due to reduced rotor weight and its effects on bearing friction, lower manufacturing costs, reduce rotor weight, reduce system noise and fatigue, reduce system vibrations, and improve system resonance. Non-rotating structures, such as the liners may be constructed of more general grades of stainless steel like 316.

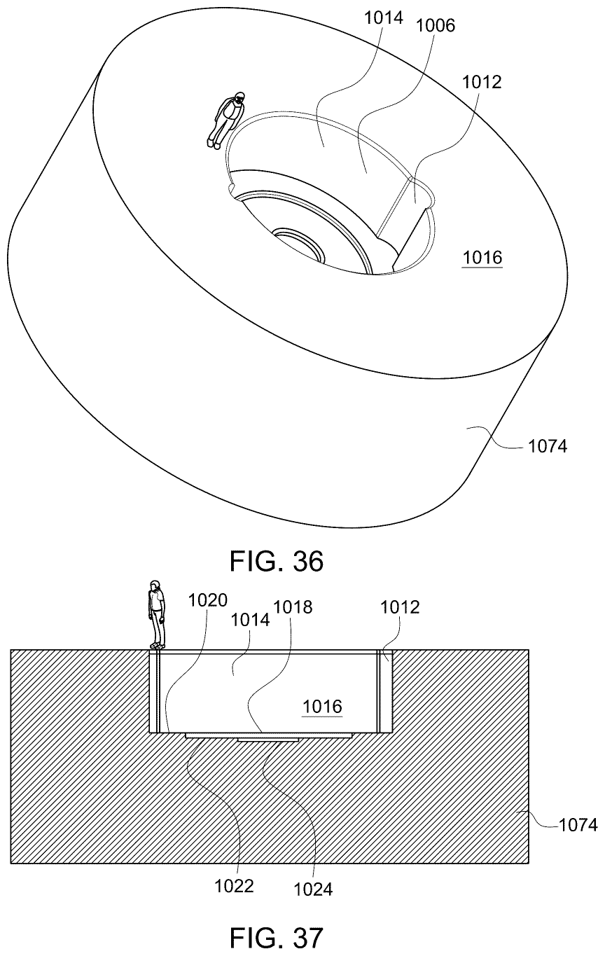

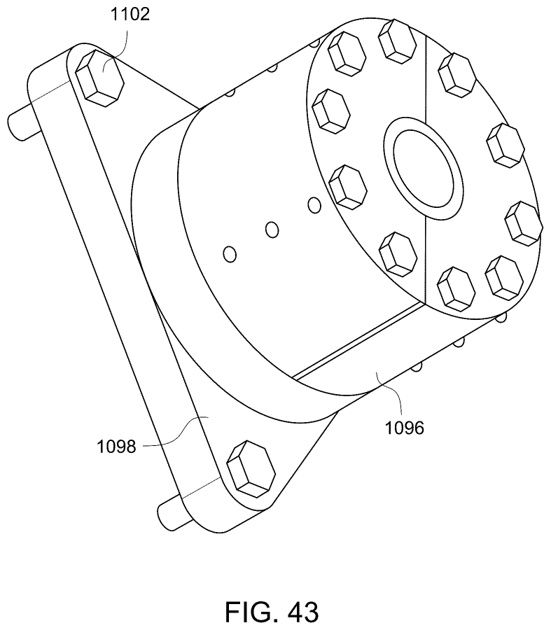

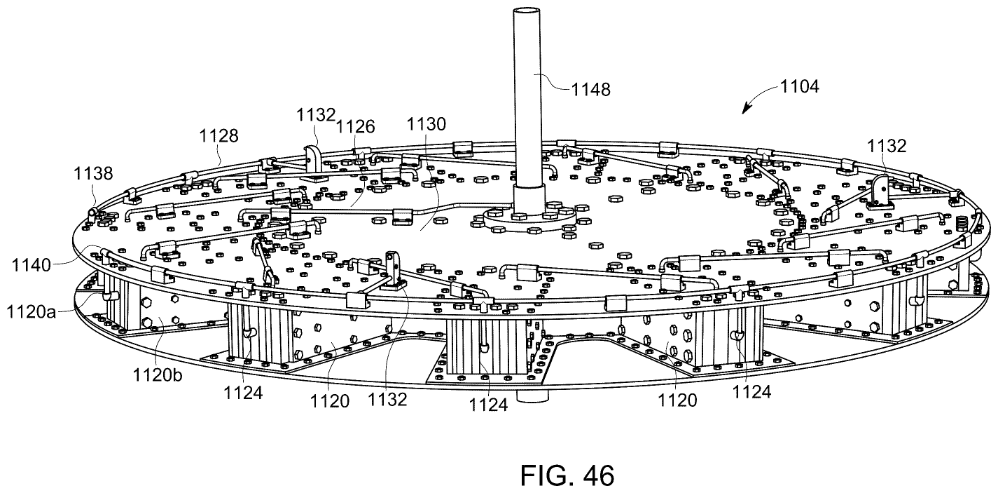

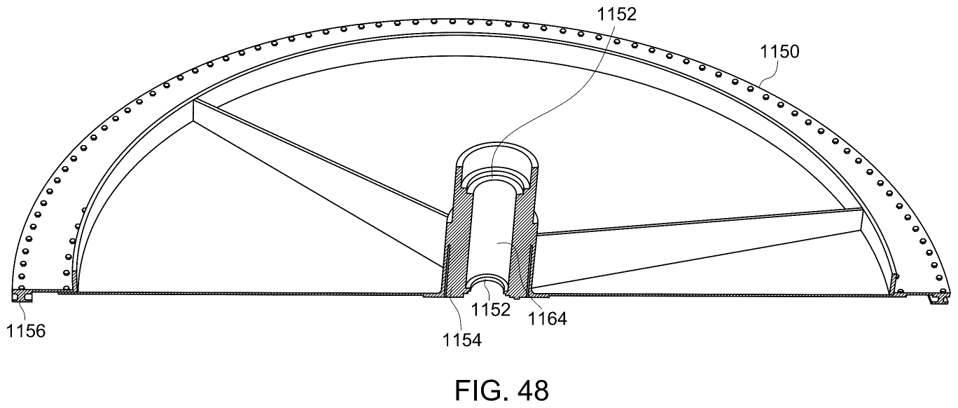

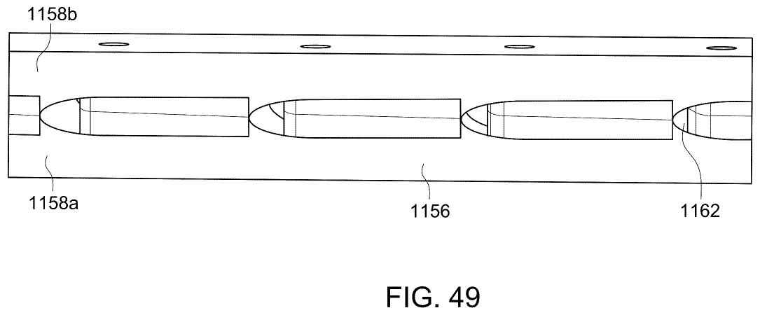

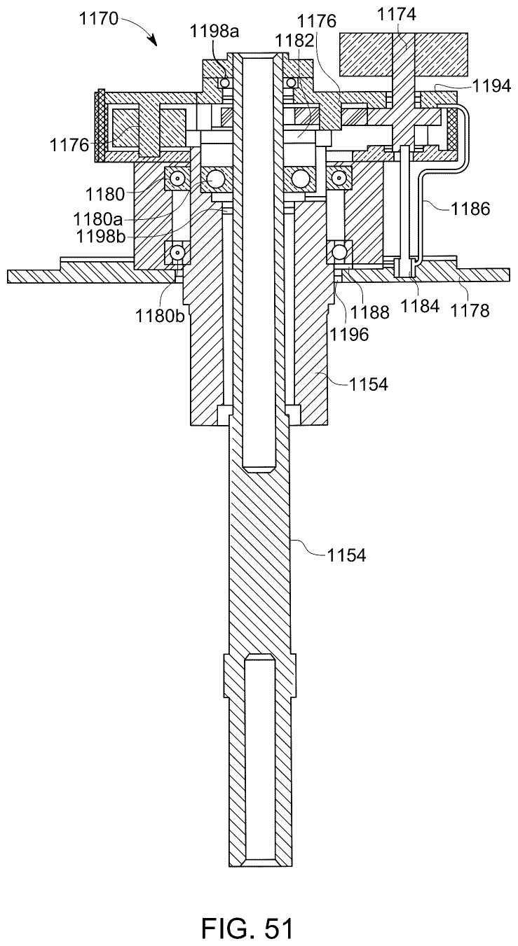

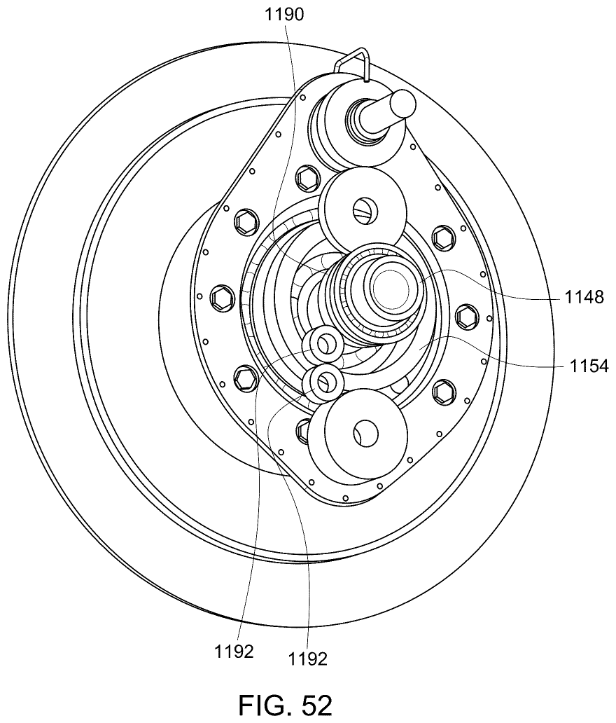

Further embodiments of a reverse osmosis centrifuge assembly are illustrated in FIGS. 36-54. As shown in FIGS. 36-37, embodiments of the assembly comprise an enclosure 1014. The enclosure 1014 may be recessed below a top surface 1016 of a support structure 1074. The support structure 1074 may comprise concrete, earth, or other appropriate materials. The support structure may be recessed into a surround ground level or may extend above the surrounding ground.

The enclosure 1014 may be generally cylindrical with a vertical axis of rotation and may comprise slots 1012 that extending outwardly from a sidewall 1006 of the enclosure. In addition, the enclosure may comprise a recess 1018 in a bottom surface 1020 of the enclosure. The recess may comprise a first cylindrical recess 1022 and a second cylindrical recess 1024 that extends further into the support structure. The recesses may be centered at an axis of the enclosure.

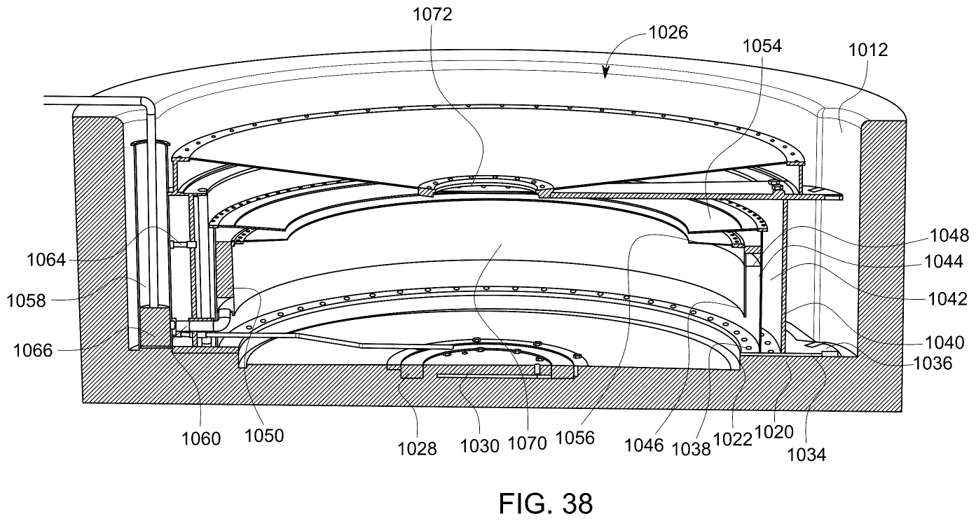

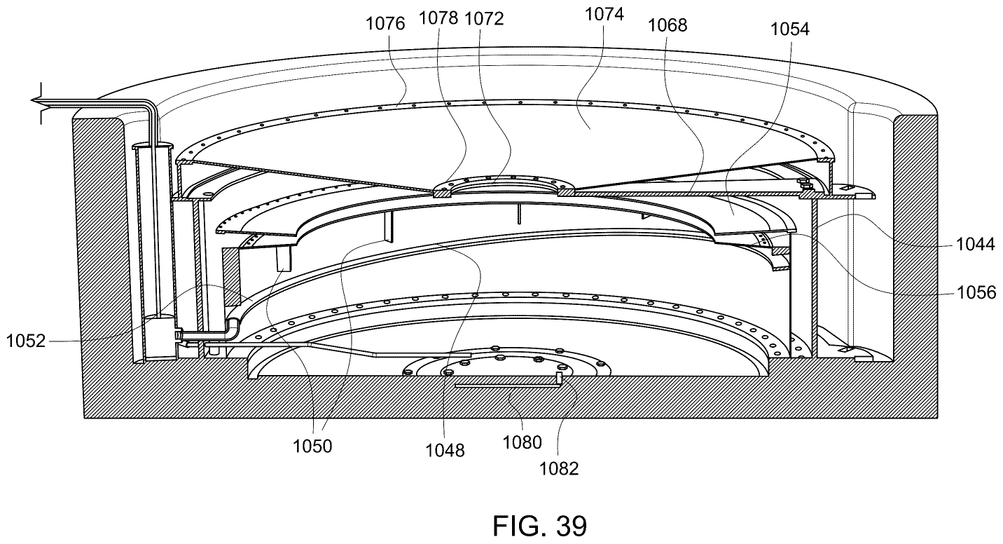

As illustrated in FIGS. 38-39, the centrifuge assembly may comprise a chamber 1026 positioned within the enclosure 1014. The chamber may comprise a bushing 1028 positioned in the second recess 1024 of the enclosure. The bushing 1028 may surround a bushing foot 1030 and may be secured to the enclosure with bolts 1032 or other fasteners. The bushing may comprise an outer race, and inner race, and a rubber bushing insert. A base flange 1034 may extend around and adjacent to the first recess 1022. Tabs 1036 may extend from the circumference of the base flange into slots 1012. These tabs may assist with locating the base flange within the enclosure. Bolts 1038 or other fasteners may secure the base flange 1034 to the lower surface 1020 of the enclosure.

An outer chamber sidewall 1040 may extend upwardly from the base flange 1034. The outer chamber sidewall may be generally cylindrical and be spaced apart from the sidewall 1006 of the enclosure. A clean water sump 1070 may be positioned inwardly from an inner surface 1042 of the chamber sidewall 1040. The clean water sump may be a non-rotating cylindrical structure, which forms a sump with annular ducting, and which receives clean water from the centrifuge rotor. The clean water sump may comprise an outer sump sidewall 1044 extending upwardly from the base flange 1034 and an inner sump sidewall 1046 that is spaced inwardly from the outer sump sidewall. The sump may further comprise a sump floor 1048 and baffles 1050 extending between the inner and outer sidewalls.

FIG. 39 illustrates the clean water sump 1070 of FIG. 38 with the inner sump sidewall (1046) removed. In this view, the baffles 1050 and floor 1048 of the clean water sump are visible. As can been seen, embodiments of the clean water sump may comprise a floor 1048 that is sloped from one side to the other such that water entering the sump will flow to the lower side 1052. The clean water sump may also comprise a lower intake flange 1056 attached to the inner sidewall 1046 and an upper intake flange 1054 attached to the outer sidewall 1044. Water being expelled from the centrifuge rotator (discussed below) passes between the upper and lower intake flanges and into the clean water sump.

Embodiments of the chamber may further comprise a clean water well 1058. A pipe 1060 extends from the low point 1052 of the clean water sump, through the chamber sidewall 1040 and into the clean water well 1058. A recovery pump 1066 may be positioned in the clean water well 1058. The pump removes the clean water from the enclosure at the same rate of clean water production of the centrifuge rotor. The recovery pump rpm may be controlled by a variable frequency drive and may be adjusted to maintain adequate water level in the clean water sump and the water well. The water well may be an adjacent cylinder which shares the same atmosphere as the enclosure. The water well 1058 and chamber 1026/enclosure 1014 may be joined by two pipes, one pipe 1060 near the bottom is where water is transferred from the clean water sump to the clean water well, and the other pipe 1064 may be positioned above the first pipe 1062 and may allow any remaining gasses to be displaced from the water well, allowing the water level to be in equilibrium with the clean water sump. The upper pipe 1064 may also serve as an overflow pipe where water can escape in the failure event of the recovery pump. The water well may be removable and fitted to the side of the enclosure. The water well 1058 receives the clean water recovery pump 1066 and a water level sensor. The water level sensor measures and the amount of clean water in the sump and water well.

The chamber 1026 may further comprise support arms 1068 positioned above the clean water sump 1070 that extend from the chamber outer sidewall 1040 to a central opening 1072. A lid 1075 may be positioned above the arms 1068 from the chamber outer sidewall 1040 to a central opening 1072. The lid 1075 may extend downwardly from a lid outer edge 1076 to the central opening 1072 such that the lid is higher at is circumference 1076 than in a central region 1078. The lid 1075 may seal the chamber, allowing a varying range of vacuum (negative) air pressure within the chamber. The chamber may be fitted with seals that fit bearing feet or any pipes and wires that extend through the enclosure walls in order to maintain the vacuum.

The enclosure may also comprise a residual water well 1080 that may be used to recover residual water from the chamber. Residual water may build up from misting of the turbine, and evaporation, or any leaks during assembly or running. The intake 1082 of a residual water pump (not shown) may be at the base of the enclosure where a sump 1080 is formed. The residual pump may turn on and off based on the water level in the enclosure sump.

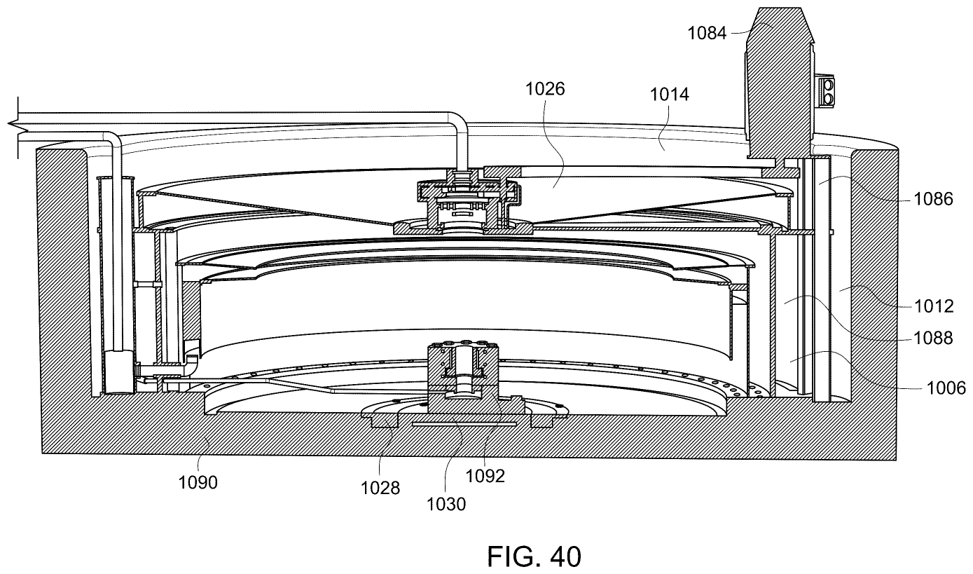

As illustrated in FIG. 40, the chamber 1026 locates and secures the drive motor 1084 for the centrifuge rotor (discussed below). The motor may be positioned on welded structures 1086 within the enclosure 1014 and attached to the chamber 1026 structure. The chamber is positioned in the enclosure 1014, which may comprise a concrete or concrete lined pit, as deep or deeper than the chamber. An empty space 1088 may be positioned between the enclosure sidewall 1006 and the chamber 1026. This space 1088 may be filled with sand, water, soil, or any appropriate dampening material. In embodiments of the centrifuge assembly, the chamber 1026 is only fastened to the enclosure 1014 at the base 1090 of the enclosure, enabling the chamber to have a relative movement which increases near the top, where the energy of a failure can be expressed and transferred to the dampening material. At the center and base of the enclosure is a bushing 1028 and plate or bushing foot 1030, which locates the base bearing foot 1092.

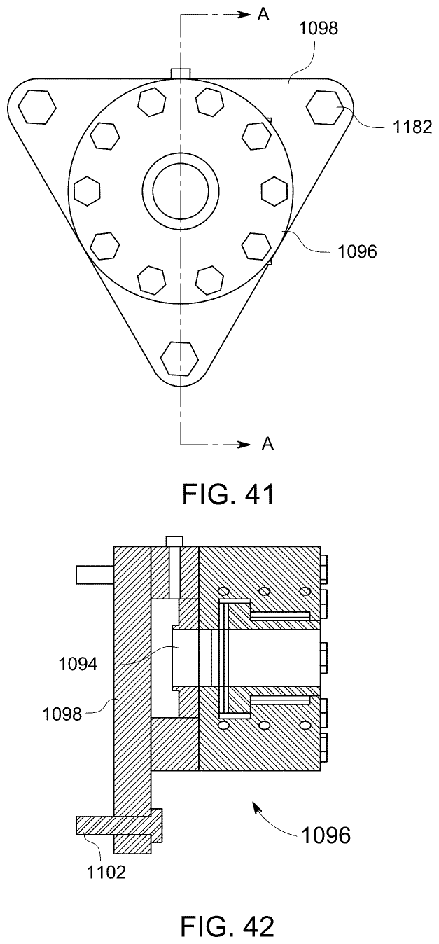

As illustrated in FIGS. 41-43, the base bearing foot 1092 secures the bottom end of the centrifuge axle (not shown) and houses a mechanical seal 1094 that delivers the reject stream to the enclosure plumbing. The base bearing foot uses a hydrodynamic thrust and journal bearing 1096 to handle the combined loads of the centrifuge axle. The bearing foot 1092 may comprise a plate 1098 that is secured to the bushing foot 1030 by one or more bolts 1102. The plate 1098 may be triangular. A bushing (not shown) may also be used on bearing foot. The bushing is a large rubber ring with a stainless steel outer and inner race. The outer race is bolted to the concrete floor, and the inner race is bolted to the bearing foot. The bushing is designed to dampen aggressive vibrations should an out of balance event occur. The bushings inner race and bearing foot are able to have a relative movement which compresses and decompresses the bushing material. The out race of the bushing is fixed. The enclosure, chamber, dampening material, and bushing work together to contain the energy of a structure failure event of the rotating bodies.

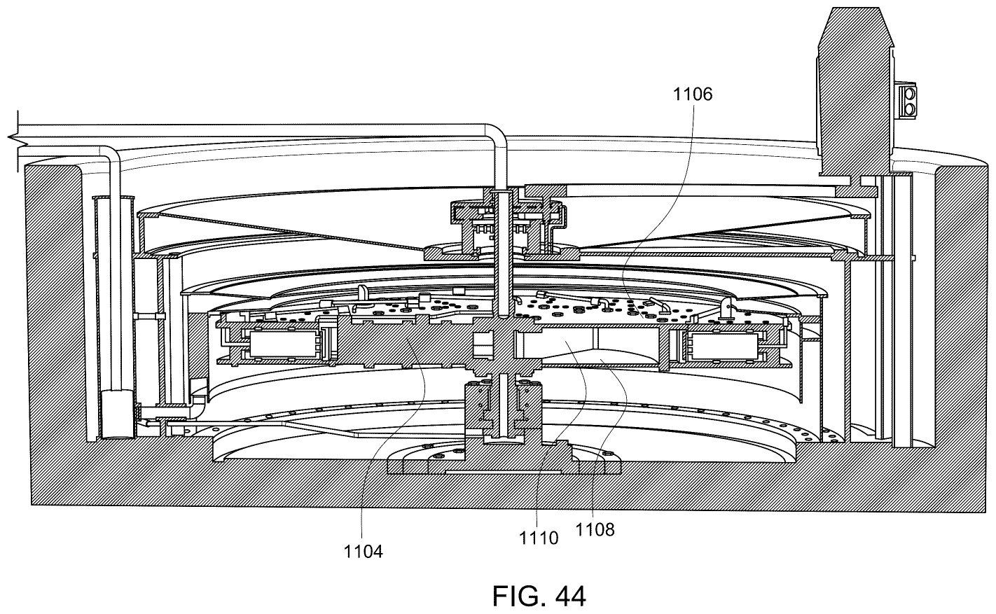

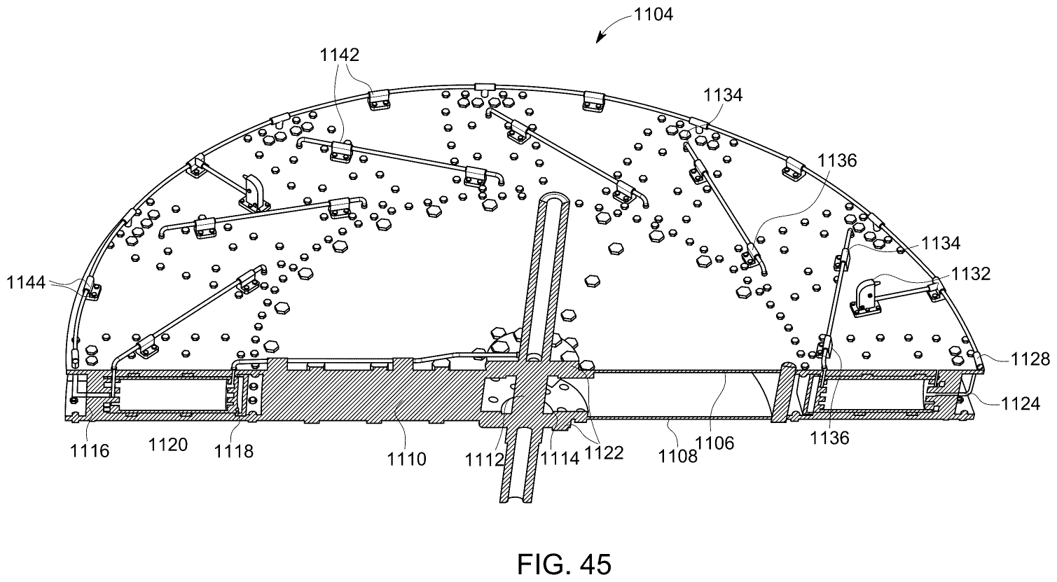

As illustrated in FIGS. 44-45, the centrifuge assembly may comprise a centrifuge rotor 1104. The centrifuge rotor may be constructed from top 1106 and bottom 1108 plates and brackets 1110. The plates and brackets may be made from high carbon steel. The rotor 1104 may comprise a center hub 1112, which may be rolled and welded steel plate with gussets 1114. The outer region of the rotor contains plates 1116 and brackets 1118 which retain each pressure vessel 1120. The rotor components may be bolted and threaded or through bolted. The center 1112 of the rotor may be bolted to two taper bushings 1122 which are bolted and tightened on the axle. The axle may be made from super duplex stainless steel or a highly corrosive resistant material. The rotor plates may have lathe turned edges from which the hub can be located and may also have dowel pins from which the vessel retaining brackets can be located. The axle may have several lathe turned edges that locate the taper bushings, which also locates the rotor.

The fasteners and hardware that secure the rotor components and plumbing may be safety wired. The safety wire may be used to secure and prevent any fasteners from slowly loosening over time due to potential vibrations. Many of the rotor fasteners may never be removed. For example, only several fasteners near the circumference may need to be removed to remove a pressure vessel along with the ported fittings.

The rotor 1104 may be fitted with multiple vessels 1120, in the illustrated embodiment there are twelve. Each pressure vessel is connected in series with respect to each other. The reject from one vessel (e.g., 1134) is the feed for the subsequent input (e.g., 1136), and so on. The clean water ports 1124 are connected in parallel with each other. Each pressure vessel 1120 may be made from super duplex stainless steel or a highly corrosive resistant material. The pressure vessels 1124 are side and axially ported. The side ports feed a geometry in the end caps which evenly distributes the flow across the face of the reverse osmosis membrane. The side ports are where the feed and reject (feed, brine, concentrate) are pumped, and the base axial port is where the clean water (permeate, filtrate) is pumped. The feed/brine 1126 and permeate 1128 plumbing are secured to the top surface 1130 of the centrifuge rotor 1104 and are connected to the vessels through the side ports. The rotor may comprise an outlet 1105 that allows permeate to flow from a periphery of the rotor. This outlet may comprise permeate ports 1124 that reach around the outside to the top of the rotor and feed to a circular pipe 1128 revolving the rotor. This circular pipe 1128 feeds three jets 1132 in parallel, which eject water into the intake of the recovery turbine. More or fewer jets may be used. The plumbing may be made from super duplex stainless steel, or a highly corrosive resistant material.

Embodiments of the circular pipe 1128 are not continuous and are capped 1138,1140 between the first 1120a and last 1120b vessel. This may provide an advantage of preventing the body of water in the circular pipe from rotating relative to the centrifuge rotor 1104. Excessive flow in this circular pipe could create pumping head losses. The plumbing may also be secured to the rotor with brackets 1142 and fasteners 1144. The region of the rotor where the membranes are positioned may or may not have additional plates in between the larger circular plates and the vessel brackets. The addition of these plates increases the thickness of the rotor in these regions, which increases the overall strength. The area of the rotor where the vessels are retained may experience the most deformation, thus requiring the most strength and reliability. In addition, one or more balancing bolts may be positioned around the circumference of the rotor, in between the pressure vessels. Different weights may be added along the length of the balancing bolt(s) to balance not only around the circumference but along the axis of rotation.

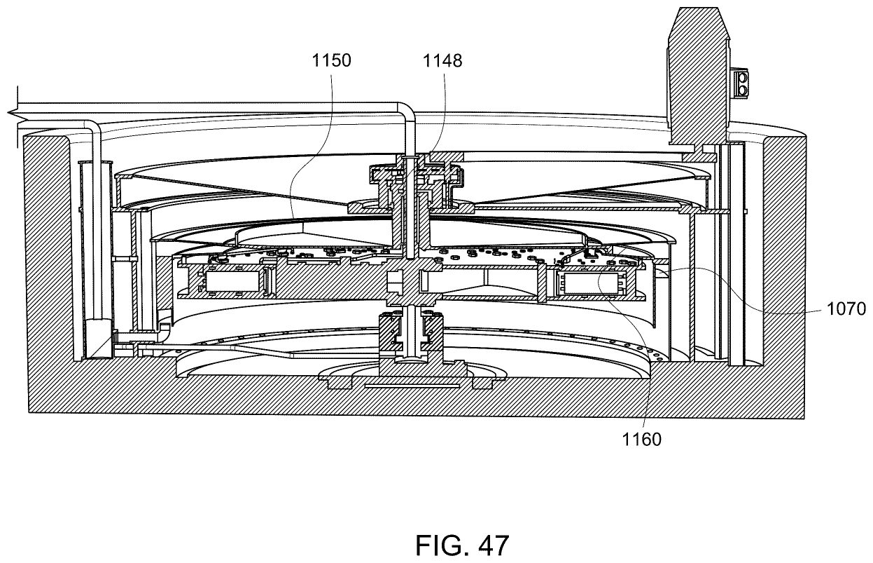

As illustrated in FIGS. 47-49, the centrifuge assembly may comprise a turbine 1150. The turbine may comprise a rotating structure positioned on bearings 1152 that fit over the centrifuge rotor axle 1148. The turbine may be made from rolled and welded plate, which is then lathe turned to create true and concentric surfaces for mounting and locating the turbine blade sets 1156 and the turbine axle 1154. The turbine blades may be an impulse turbine that are designed to receive water from an annulus form from a radially inward position. This differs from prior impulse turbines, where normally the fluid is ejected into the turbine blades from stationary nozzles which are in radially outward position. The turbine blades may be made from stainless steel or a corrosive resistant material. The blades may be machined on a 3 axis mill with basic 3D machining capabilities, and are sandwiched together from two mirroring halves 1158a, 1158b. Through bolts secure the two halves together against the turbine wheel. The turbine blades are positioned in the inlet annulus 1160 of the clean water sump 1070. The exhaust ports 1162 of the turbine release a low energy annulus of clean water into the sump inlet. The turbine 1150 is positioned above the centrifuge rotor 1104, and rotates at a reduced speed, no faster than half the speed of the centrifuge rotor in the same direction. The turbine is geared to the centrifuge axle by use of the drivetrain gearbox (discussed below). The turbine blades 1156 absorb the kinetic energy of the clean water once it is ejected from the centrifuge rotor. The turbine recovers the kinetic energy from the clean water, and converts it into rotational energy, or torque. The outlet of the turbine blade ejects the clean water into the ducting of the clean water sump. The top bearing supporting the turbine, and the turbine gear are located in the gear case, which is actively lubricated. The base bearing 1164 is sealed in a separate atmosphere and is permanently lubricated. Double backed oil and vacuum seals are used between the turbine, and the centrifuge axle/bearing foot.

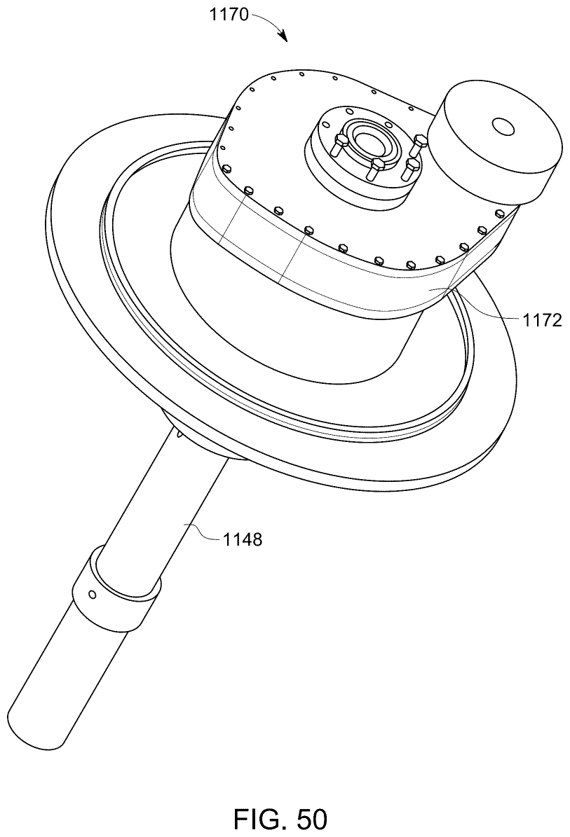

As illustrated in FIGS. 50-52, the centrifuge assembly may comprise a drivetrain 1170. The drivetrain may comprise a case 1172 of gears with several shafts rotating with each other. These shafts consist of the drive pulley shaft 1174, centrifuge axle 1148, turbine axle 1154 and several pins positioning gears 1176. The drive train case 1172 is positioned on a bearing foot 1178 that contains ball bearings 1180 that guide the centrifuge axle 1148 and the turbine axle 1154. There is a bearing 1180a between the centrifuge axle and the turbine axle, and there is a bearing 1180b between the turbine axle and the non-rotating bearing fixturing. The illustrated structure of a multi bearing arrangement, where two bearings are radially opposed to each other, allows the turbine axle to have an upper section 1182 that reaches above the bearings, which makes a singular gear train feasible. If prior single bearing structures were used, the turbine gearing would have to be located below the bearing foot 1178, while the drive gears would be above the bearing foot.

The gears and bearings are exposed to the same cased enclosure 1172, which is actively lubricated by use of a positive displacement oil pump 1184. The oil is pumped above the top gears through pipe 1186 and, by gravity, drains down across the gear teeth and into the bearings. The oil pump intake 1188 is below the bottom bearing 1180b. A screen may be positioned above the bearings to catch any debris from the gear train. The oil pump intake may also feature a screen in its intake.

The gear train between the centrifuge axle 1148 and turbine axle 1154 is configured with one large adjacent gear 1190 and two small gears 1192 and forms a “jackshaft”. This can also be configured to take the form of a planetary gear arrangement and achieve the same gear ratio. The gears may be spur, herringbone, or helical. In the illustrative gearbox, the turbine and centrifuge axle are geared to each other at no more than a 2 to 1 gear ratio. Assuming the turbine is 100% efficient, it would rotate once for every 2 rotations of the centrifuge. The final gear ratio will be based on what RPM the turbine produces the most energy, at a given centrifuge RPM. The gears, not including the centrifuge and turbine axle gears, ride on fixed pins 1176 which are drip lubricated by the oil pump. The gears on the centrifuge and turbine axle are secured by bolts to their respective axle shaft. The drive pulley axle 1174 rides on radial ball bearings 1194. However, some or all of the remaining gears may be supported by bearings. The gaps at the base of the drivetrain axles are double sealed with an oil and vacuum seal 1196. A bearing and mechanical seal 1198a, 1198b are positioned on the top and the drivetrain gearbox 1172 and on the centrifuge axle. The bearing keeps the axle in alignment with the mechanical seals. The mechanical seal forms a sealed chamber where water can be pumped from the non-rotating plumbing into the rotating axle of the centrifuge.

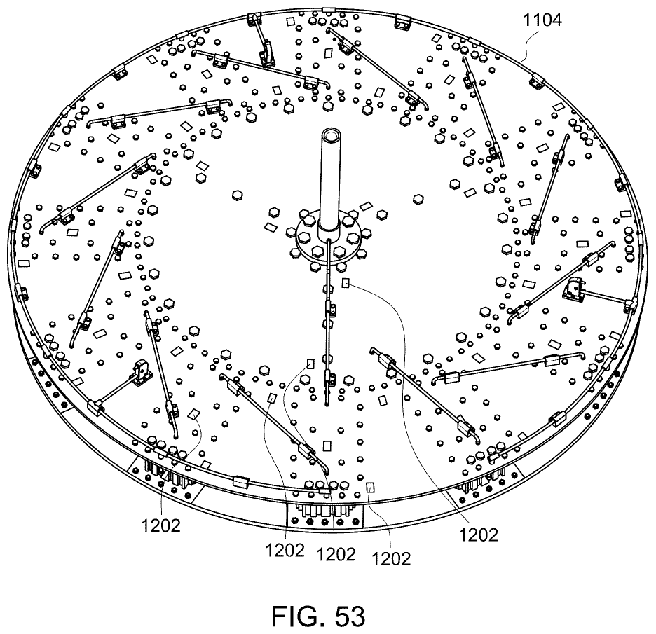

Embodiments of the centrifuge assembly may incorporate rpm sensors, flow sensors, pressure sensors, strain gauges, water level sensors and accelerometers. As illustrated in FIG. 53, the centrifuge rotor 1104 may be dressed with strain gauges 1202, which may require a charging system and/or Bluetooth (or other wireless) transceiver in order to communicate with sensors located on a rotating body. The charging system may power strain gauges, pressure sensors, a wireless transceiver, and any accessory electronic boards required for the instrumentation. The non dynamic components of the centrifuge may feature an rpm sensor, flow rate sensor, water level sensor and accelerometers. Some of these sensors may be featured on the centrifuge rotor or any dynamic component of the centrifuge assembly. A water level sensor may be used in the water well (1058) to measure the water level in the clean water sump (1070). A trend analysis program may measure the strain gauges and accelerometers, and through software algorithms, determine what are acceptable and unacceptable mechanical stresses throughout the rotor bodies. If unacceptable forces are seen or predicted by the trend analysis, an alarm can be thrown to notify an attendant or engage the shutdown sequence of the centrifuge.

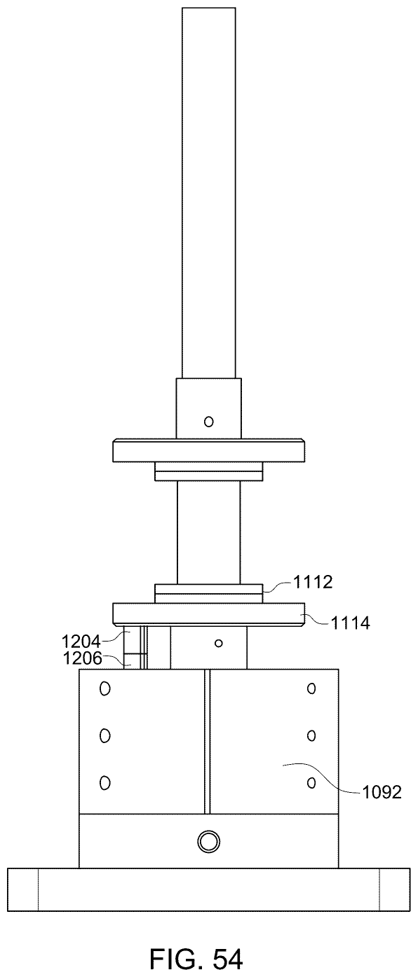

As illustrated in FIG. 54, a coil 1204 may be attached to the centrifugal rotor central hub 1112 and may preferably be attached to a gusset 1114 of the central hub. The coil may be electrically connected with sensors attached to the centrifugal rotor. A corresponding magnet 1206 may be attached to the bearing foot 1092 such that a current is induced in the coil as the centrifuge rotates, thereby providing electrical power to the centrifuge rotor. A single control board may contain the circuitry used to drive the strain gauges and other rotor sensors, convert the coil and magnet electricity from an alternating to direct signal, and have transmitting and receiving capabilities. The control board may also have a battery that is trickle charged by the coil and magnet, and the battery would power the control board and sensors. The main control board may be separated from the centrifuge assembly and located in a separate room where multiple centrifuges in a plant could be electronically managed.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A centrifuge assembly comprising:
a centrifuge enclosure extending downward from a ground level of a support structure such that the enclosure is embedded in the support structure, the centrifuge enclosure comprising:
a cylindrical sidewall comprising an upper end and a lower end,
a lid adjacent the upper end of the sidewall, the lid comprising a central opening through which a flow of feed fluid passes and at least partially covering the enclosure, and
a lower surface adjacent to the lower end of the sidewall, the lower surface comprising an opening through which a flow of reject fluid passes; and
a centrifuge positioned within the enclosure, the centrifuge comprising:
an axle extending between the enclosure lid and lower surface; and
a centrifuge rotor.

2. The centrifuge assembly of claim 1 wherein the lid is recessed below the ground level.

3. The centrifuge assembly of claim 1 wherein the lid comprises an outer edge and a central opening.

4. The centrifuge assembly of claim 3 wherein the lid extends downwardly from the lid outer edge to the lid central opening such that the central opening is positioned below the lid outer edge in a direction parallel to a central axis of the centrifuge.

5. The centrifuge assembly of claim 1 further comprising a vacuum source that reduces an internal pressure of the centrifuge assembly relative to an ambient pressure.

6. The centrifuge assembly of claim 5 wherein the lid seals the centrifuge enclosure sufficiently to provide for the reduced internal pressure.

7. The centrifuge assembly of claim 1 wherein the centrifuge comprises an outlet configured to allow permeate to flow from a periphery of the centrifuge.

8. The centrifuge assembly of claim 7 further comprising a chamber positioned in the enclosure and at least partially surrounding the centrifuge.

9. The centrifuge assembly of claim 8 wherein the chamber comprises a sidewall and upper and lower intake flanges extending from the sidewall.

10. The centrifuge assembly of claim 9 wherein the periphery of the centrifuge extends between the upper and lower intake flanges and does not contact the upper and lower intake flanges.

11. The centrifuge assembly of claim 9 wherein the chamber further comprises a clean water sump, the clean water sump comprising a cylindrical structure that surrounds at least a portion of the centrifuge.

12. The centrifuge assembly of claim 11 wherein the clean water sump comprises baffles.

13. The centrifuge assembly of claim 11 further comprising a clean water well and a pipe extending from the clean water sump, through the chamber sidewall, and into the clean water well.

14. The centrifuge assembly of claim 1 wherein the centrifuge comprises a sensor attached to the centrifuge rotor.

15. The centrifuge assembly of 14 wherein the centrifuge rotor comprises a plate, and the centrifuge comprises multiple strain gauges attached to the plate.

16. A centrifuge assembly comprising:
a centrifuge comprising a feed fluid inlet, a permeate outlet, and a concentrate outlet, the centrifuge further comprising an axle and a hub;
a bearing foot that supports a lower end of the centrifuge axle;
a support structure to which the bearing foot is attached; and
an enclosure surrounded by the support structure and extending downwardly into the support structure from a support structure upper surface, the enclosure comprising:
a cylindrical sidewall comprising an upper end and a lower end,
a lid adjacent the upper end of the sidewall, the lid comprising a central opening through which a flow of feed fluid passes and at least partially covering the enclosure, and
a lower surface adjacent to the lower end of the sidewall, the lower surface comprising an opening through which a flow of reject fluid passes;
an upper bearing attached at the lid central opening.

17. The centrifuge assembly of claim 16 wherein the support structure is recessed below a surrounding ground level.

18. The centrifuge assembly of claim 16 wherein the enclosure comprises a concrete lined pit extending into the support structure.

19. The centrifuge assembly of claim 16 further comprising a clean water sump, a clean water well, and a first pipe extending from a low point of the clean water sump to the clean water well.

20. The centrifuge assembly of claim 19 further comprising a second pipe extending from the clean water sump to the clean water well at a position that is above and spaced apart from the first pipe.
